(19) United States
(12) Patent Application Publication
(10) Pub. No.: US 2007/0150299 A1
(43) Pub. Date: Jun. 28, 2007

(54) Method, system, and apparatus for the management of the electronic files

(76) Inventor: Clive F. Flory, Arlington, VA (US)

Correspondence Address: MAXVALUEIP CONSULTING, 11204 ALBERMYRTLE ROAD, POTOMAC, MD, 20854, US

(21) Appl. No.: 11/614,983

(22) Filed: Dec. 22, 2006

Related U.S. Application Data
(60) Provisional application No. 60/753,370, filed on Dec. 22, 2005.

(51) Int. Cl. G06Q 99/00

(52) U.S. Cl. 705/1

(57) ABSTRACT

The primary design goals of the current system are (as a matter of example, but not limited to the following, by any means): to enable Organizations to send documents to Readers ensuring that only those authorized Readers can “read” the contents; to be a low cost, easy to use system, with zero to minimum installation requirements at the Companies and Readers end; to provide the service primarily as an ASP service with the ability to be easily deployed and maintained into an Enterprise environment; to enable Companies to send documents anywhere in the world and receive the same level of protection and comfort regardless of location of Reader; to provide a centrally managed, but distributed, Reader authentication and authorization method/process for all Companies to use in any country; to provide a central NDA (Non Disclosure Agreement) Registry for any size company; and to provide a secure guaranteed on-line signing process for business contracts and agreements.

### RELATED INVENTION(S)

The present application is related to the U.S. provisional application, Ser. No. 60/753,370, filed Dec. 22, 2005, titled “Method and systems for network-based management of electronic files,” with the same inventor and the same assignee.

### BACKGROUND

The present invention relates generally to the management of the electronic files, and more particularly, to methods and systems for network-based management of shared electronic files.

The Business Problem:

Most business is conducted within a closed circle of trusted people, where the sharing of sensitive and confidential business information through the exchange of documents, a web site , an exposed business blog is a natural part of the way business is conducted. Digital documents increasingly contain the most detailed and sensitive business information so, ensuring that such documents are seen only by the intended audience, has become a major concern. This is particularly true when documents, web sites , blogs are shared between businesses.

The digital world makes For Your Eyes Only (FYEO) document security difficult to setup and maintain. Most have tackled the FYEO issue by placing sensitive documents in file systems resembling digital fortresses, made up of expensive IT infrastructure. While these fortresses succeed in preventing any unauthorized intrusions in situ, once a document leaves these safe zones, it becomes vulnerable. Password protection is not enough because passwords are often shared. Digital certificates and public private keys are not wide spread and they don't provide “continuous and persistent” protection for the Author once the document has been opened. So persistent, continuous protection of any type of document has not been fully addressed.

To address this critical problem, Ostiary has developed this technology to ensure that any document managed by the Ostiary system maintains its FYEO status, regardless of who has the documents or where in the world they reside.

Ostiary is building an easy to use and powerful Web based service to allow employees to safely share “business sensitive” digital documents such that unwanted leaks to unauthorized people are greatly reduced. Ostiary protects sensitive digital content from unwanted eyes.

### SUMMARY OF THE INVENTION

What is a Business Sensitive Document:

A business sensitive document is any document created by an application such as Word processors, Presentation applications, Spreadsheets, CAD, Design apps, which contains information that only a select and authorized group should see. There is a financial risk associated with a leak of these documents.

Examples are:

Information about a Merger or Acquisition
A companies Financial Information
Proprietary information shared with a corporate partner.
Information about a NEW product Launch
Research information around a proposed new patent
HR/compensation Information on employees
An Intranet Web Site
   The Primary Design Goals of the System:
To enable Organizations to send documents to Readers ensuring that only those authorized Readers can “read” the contents. This is the FYEO service
To be a low cost, easy to use system with zero to minimum installation requirements at the Companies and Readers end
To provide the service primarily as an ASP service with the ability to be easily deployed and maintained into an Enterprise environment
To enable Companies to send documents anywhere in the world and receive the same level of protection and comfort regardless of location of Reader
To provide a centrally managed but distributed Reader authentication and authorization method/process for all Companies to use in any country
To provide the foundation of a Reader, Document delivery agent, digital Identity created from a composite of elements.
To leverage the elements of the inherent structure of the public Internet to achieve the goals
To provide a central NDA (Non Disclosure Agreement) Registry for any size company
To provide a secure guaranteed on-line signing process for business contracts and agreements
To provide an asynchronous threaded messaging system/method that links the threaded message to a document, a page in a document and a section of a page in a document
To provide a method to segregate threaded document messages into two or more “message” channels such as Private and public channels.

The document below separates the FYEO service from the NDA Registry Service even though at some level they are linked. Neither of these services are dependant on each other and it is envisaged that customers will take up one or the other or both: A process to ascertain the identity of a person of specific information; and ascertain the source of a document and that it has not been modified.
The main aim of the invention is to provide an Author or publisher persistent and perpetual control on the access to their digital object creation and the rights and privileges once access has been granted. This control is governed by an authentication mechanism that requires the accessor to present sufficient identity elements as needed by the Author or publisher for a particular digital object to determine access rights. Once access rights are granted then the systems provides the mechanism for persistent and perpetual control of the accessor's rights and privileges during the access session.
Furthermore the system provides the mechanism to enable Authors and publishers to allow accessors to discuss aspects of the digital object by making comments and responses to comments as threaded messages or conversations that are linked to all or specific parts of the digital object.
Furthermore the system provides a mechanism that enables ALL participants Authors, Publishers and Accessors the means to view and manage the interactions that occur during a discussion around an object.
Furthermore the system leverages the built up identity of a user and utilizes this to enable a digital object to be signed such that WHO signed is unambiguous. This enables the system to serve in court as a witness to a signature event
Furthermore the system enables discussions around a digital object to be segregated into separate channels that are deemed public for all participants to see or private for a select group to see
Furthermore the system provides a mechanism that enables Authors to manage different versions of the same original digital object
Furthermore the system provides a mechanism that enables the Author to secure a digital object ONCE thus generating ONE unique key while enabling one or more segregated readers to have access to the digital object thus sharing the unique key while being separated by a virtual wall. Once separated ALL conversations and discussions made by the separated groups remain separated even though its around the SAME document
Furthermore the system provides the mechanism to enable an Author to deliver the digital object and get a receipt of delivery and receipt of initial access.
Furthermore the system provides the mechanism to alert the Author when there has been an unauthorized access attempt by a member of the Ostiary community
Furthermore the system provides a mechanism to enable the Author AND the Readers to be notified on key events that occur around the digital object such as Who opened the object and when, Who made a comment or response and when, who signed and when, who has NOT commented
Furthermore the system uses a Ostiary Client which can be expressed as a desktop application or a browser based plug-in provides the functionality to render or play the appropriate digital object
Furthermore the system provides a mechanism to enable authors and readers to link digital objects to each other like citations or web sites
Furthermore the system provides a mechanism to enable users to have access to the system regardless of how many email IDS they have or devices they use
Furthermore the system enables an Administrator to change the Author ownership of one more object access keys without being able to access the objects themselves.
Furthermore the system has the means to provide a network view of the relationships authors and readers have to each other through the degree if object exchange AND discussion (comment/response) intensity
Furthermore the system provides a mechanism to enable authors and readers to have their personal address books synchronized when changes are made in any related address book
Furthermore the system provides a mechanism to enable Readers in a circle to inherit keywords applied by the author and add their own
Furthermore the system is able to use any type of Identity method or combination (Email ID, Password, Biometrics , digital certificates, cell phone id, USB number generator etc) as part of the authentication process
Furthermore the system enables a federated approach to the authentication of users so identity servers can be distributed and managed by one or many groups including corporations themselves
Furthermore the system enables a federated approach to managing digital object keys so keys can be managed by groups that generate the object keys such as corporations
Furthermore the system enables the federated approach to managing the comments response messaging threads so these threads can be managed by groups that generate the message threads for the digital objects that they control
Furthermore the system provides the mechanism to move a threaded conversation from version to version of a digital object
Furthermore the system manages the registered Authors and readers as part of a community
Furthermore the system has a mechanism that enables 2 or more participants to share the simultaneous viewing of a document inside the Ostiary viewer where one of the participants has the control of the document and controls the changes, actions, movements of the document that others can see, similar to a proxy for the other one. The action of one is displayed simultaneously in another site, as well. The history of the interactions is expressed in a network of the relationships.
The frequency of interactions for one or more documents is expressed as the intensity of the relationships, and over time, for each person, we will have a network of the relationships. (shared network)
In a document, at the comment level, the more comments one has for another person, the stronger the communication relationship becomes between those two people. (Communication Network)
When an author creates a web log or a document, the frequency of the usage of the keyword is an indication of the interest level for the author with respect to that subject matter. This can be used for citation, labeling, or categorizing, which can be used for many purposes, such as marketing.
Classification can also be done for two or more keywords sharing some basic or fundamental concepts, based on the proximity of those concepts, e.g. to be able to classify the blogs.
Dashboard reflects the history and activities. In particular, it is dynamically changing. For example, if a comment comes in, the item goes up in the list.
Furthermore users in a shared conference and pass control to participants in the conference
Furthermore the system has the mechanism to apply user created keywords to a digital object to enable grouping objects around those keywords
Furthermore the system has the mechanism to enable participants of a shared object to share inherit the Authors keywords
Furthermore the system has the ability for a group to expose and analyze the social interactions that arise from the shared objects
Furthermore the system has the mechanism to expose the intensity of the interactions a user has to the System, a group, a organization to individuals
Furthermore the system has the mechanism to display all a users activity in a dashboard that dynamically displays the changes to the states of the secured objects as they occur
Furthermore the system has a mechanism to keep the location of a digital object and use this information wherever needed
Furthermore a digital Object Key is linked to one or more of a user's Identity Elements. The primary and initial identify element is a users email ID
Furthermore the system has the mechanism that enables an Author to let other Readers ADD additional readers to a secured Digital object

In a complex situation, one may have many e-mail accounts or devices, for example. To better manage those, it is easier to correspond the unique physical attributes of a user to the many digital attributes and multiple accounts.

Another important feature is the concept of Team-Mail, in which there is only one copy of the e-mail stored for all the recipients or users. Thus, this saves a lot of disk space. Also, there is less confusion about the version of the e-mail. In addition, the user can start from any thread in a sequence or responses, displayed in an orderly manner, and everybody else can do the same. Therefore, the size of the thread does not increase exponentially, like in a conventional e-mail. Thus, the organization is much more superior to the conventional e-mail. Inherently, the Team-mail is very secure, in that it cannot forwarded arbitrarily to a third party. Thus, our system can benefit from all of those inherent secure features.

For example, in case a person is included in a list of e-mail recipients, in the conventional e-mail system, there is no way to recover from that mistake, from the provider's point of view. However, in our system, this can be done easily, by removing the name of the wrong recipient from the list of the Team-mail (i.e. removing the access for that person), even if the mail has already been opened.

Note that services, rights, documents, and contents, each or all, can have hierarchical structure or composite structure. The rights can be delegated to others. The rights can expire or withdrawn. The service can include some codes that are executable, and can do a function or a task. The rights can be assigned based on role or context, such as in a company, for example, the CEO's rights. The database can hold the rights and name of entities involved.

### BRIEF DESCRIPTION OF THE DRAWINGS

FIGS. 1-3 show the overview of the system.

FIGS. 4-8 show the details of the components of the system.

FIGS. 9-18 show some applications, examples, and details of the system.

### DETAILED DESCRIPTION OF THE PREFERRED EMBODIMENTS

An Overview of the Ostiary System:

The following is a brief introduction and overview of the Ostiary System:

The fundamental Objects in the System:

The Ostiary set of services deals with the following fundamental objects that are the

Primary objects in the overall system:

Organization (sending and receiving)
People
   Senders: Employees of Organizations that send documents
   Readers: Authorized People that receive documents etc to read, comment, sign etc
Digital objects such as Business Documents (legal contracts, Engineering Specifications, Business Plans, Financial Spreadsheets), Music files, Video files, Web sites
Devices that are used to access, and ultimately read, play, view these digital objects. Such as :Laptop PCs, Desk Top PCs, Hand Held devices, and Cell phones,
Readers Digital IDs . This is an ID made up of a composite of elements, such as
   Device characteristics used to Read the documents
   The official Email addresses of the Reader Employee or their personal address.
   Location of Readers
   Physical characteristics such as Fingerprint
      What Triggers the Need for such a Service?

Essentially the services start when an Organization has a need to send someone a Document or file or web site that requires:
a. authentication prior to access, or/and
b. On going protection from unauthorized Access

But before a document can be sent, it has to get Ostiarised, i.e. the process of:
Registering the document
Registering its authorized Readers
Encrypting the document
Establishing the documents access and usage policy
Setting the Notifications
Setting the documents keywords
   How does the Service Start?

Before anything happens, an organization has to be a Registered as a subscriber to the service.

How does an Organization Register for Service?

To register an Organization, it goes to the www.ostiary.com web site and goes through the New Organization Subscription Process. Once the Origination has been registered, then their employees can be registered for use.

How do Employees Register to use the System?

To register, an Employee will go to the www.ostiary.com web site and go through the

New Employee Registration Process.

Once the Origination has been registered then their employees can be registered for use. Once the Employee has been registered then they can start to use the Ostiary system to Protect their documents

How is the Document Protected?

The digital objects or document delivered is never in its native form but has been processed in a way that enables only authorized Readers to:
Open the document
View the contents
Make Comments
Sign
Approve

The process of protecting the document is called “Ostiarising the document”, and essentially, it is a process that does the following:
Encrypt the document and generate the document keys
Compress the document
Generate a copy with a .ots extension e.g. “My Document.doc gets a My Document.ots generated”

Once a sensitive document is protected then it can be sent to Readers for use.

Who can Read these Documents?

IF a document is sent out to a Reader they will not be able to read the document unless they are registered by the Author in the Ostiary system as being authorized to Read such document.

How is “Authorized Readership” Registration Done?

When the author secures a document the “list of Authorized readers selected get registered at the time of securing

If an Author wants to ADD a new reader they add then at any time after the initial Securing of the document

If an author wants to remove a Reader they can remove the reader at any time after they have secured one after the reader has received and opened the document:

How does the Reader get the Document?

The way a Reader gets the document is by
An Email transmission by the Sender with the document attached using any email system
Picking up the file from some server where the reader has access
The System delivering it directly to a Readers email
   How will a Reader Read an Ostiarised Document?

To be able to read a Ostiary secure document that a Reader has received, the following conditions have to be true
STEP 1: The Reader has to be listed as an authorized reader for that particular document. This list is always established by the Author
STEP 2: The Reader has to have the necessary Ostiary software and components installed on their device (PC, Blackberry). Typical components are
   local Authentication component
   the Reader/Player application
STEP 3: The Reader and their Digital ID has to be a registered in the Ostiary Authentication System

Step 1 will be performed by the Sender.

Steps 2 and 3 will be performed by the Reader in that sequence.

How does the Reader get Registered in the Ostiary Authentication System?

When a Reader is invited to view a Digital Object this triggers a registration process for them

How does the Reader Get Initially Authenticated AND How does their Digital ID get Generated?

The Readers initial Authentication Process involves the generation of their Digital ID.

Can a Reader make Comments on a Protected Document?

The rights to make comments on a document are controlled by the Author. The system provides a mechanism to enable this .

What is the CORE Business Process in the Ostiary System?

The CORE business process is as follows:
a. Selecting an Object to be protected This is done by the Author/Publisher
b. Adding a list of Authorized users from an Address book
c. Setting the rights and privileges for the list of authorized users
d. Setting the Keywords for the digital object to enable easy search
e. Setting Notifications to enable notifications on events around a specific Digital Object
f. The Reader Registration process, Software Installation and Reader ID creation process.
g. The Authenticating a Reader process when they try to open a document
   System:

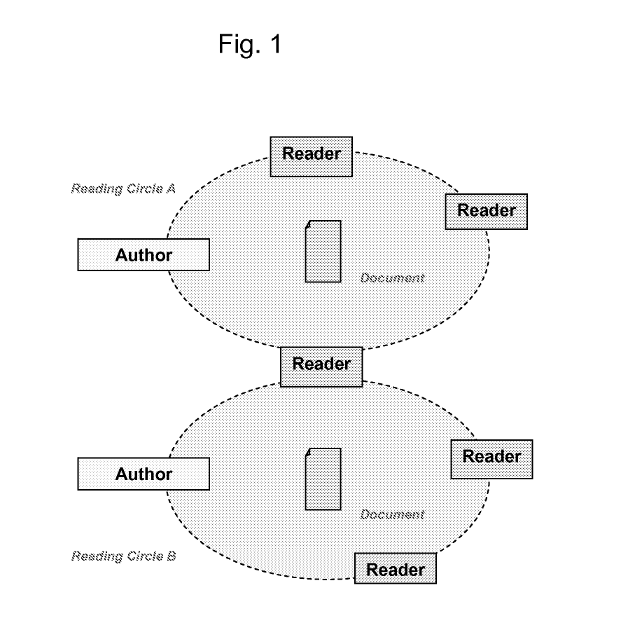

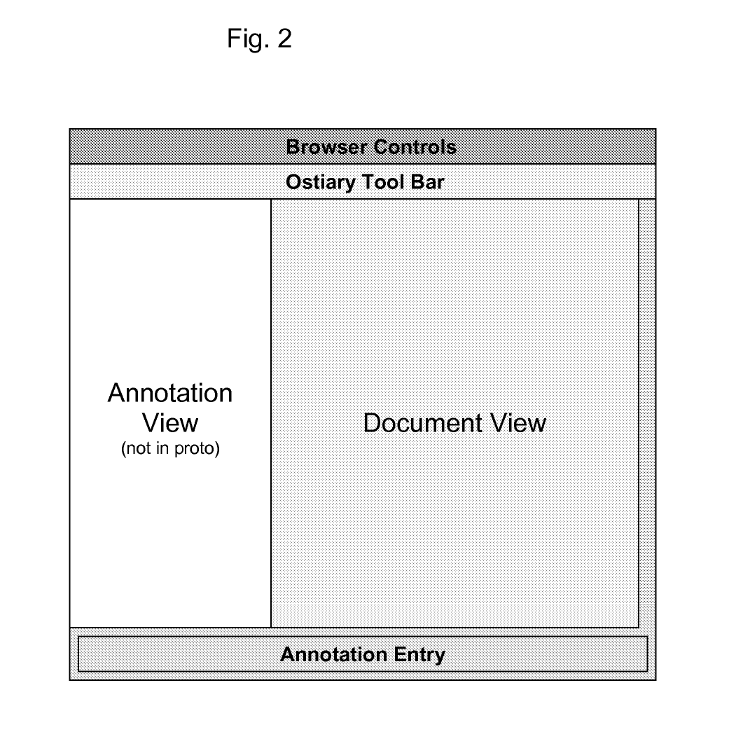

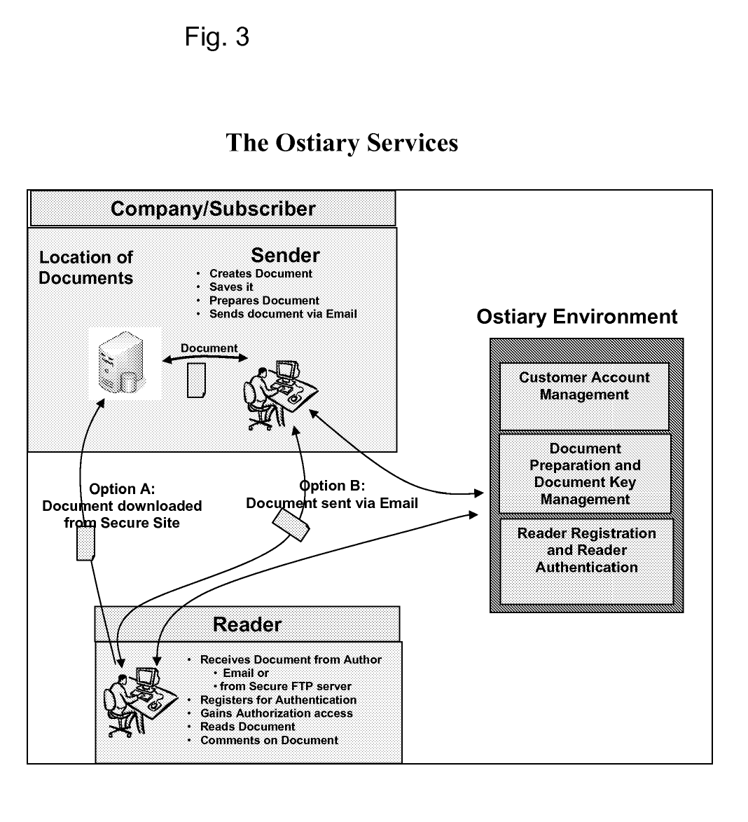

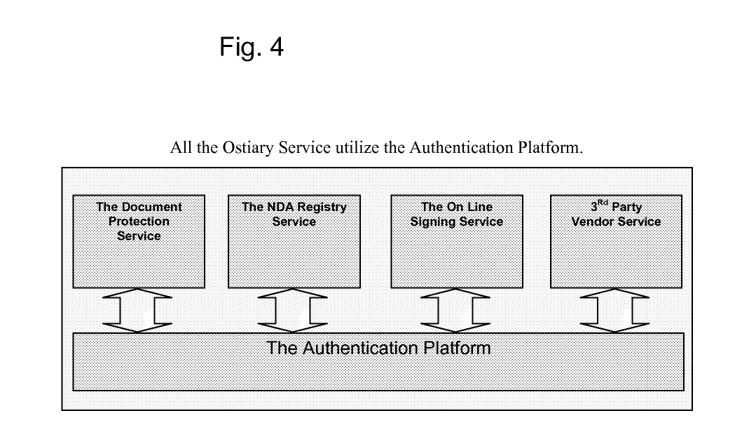

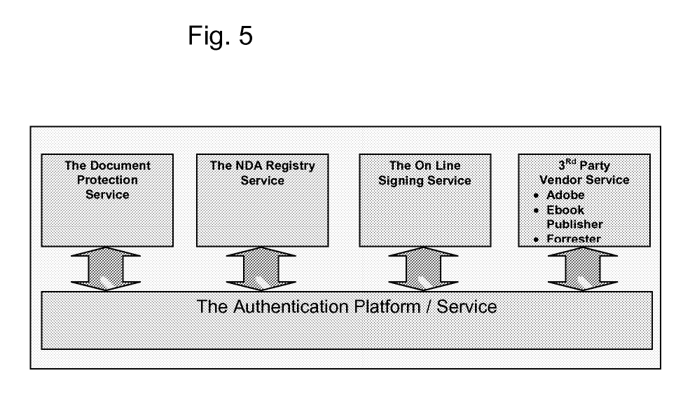

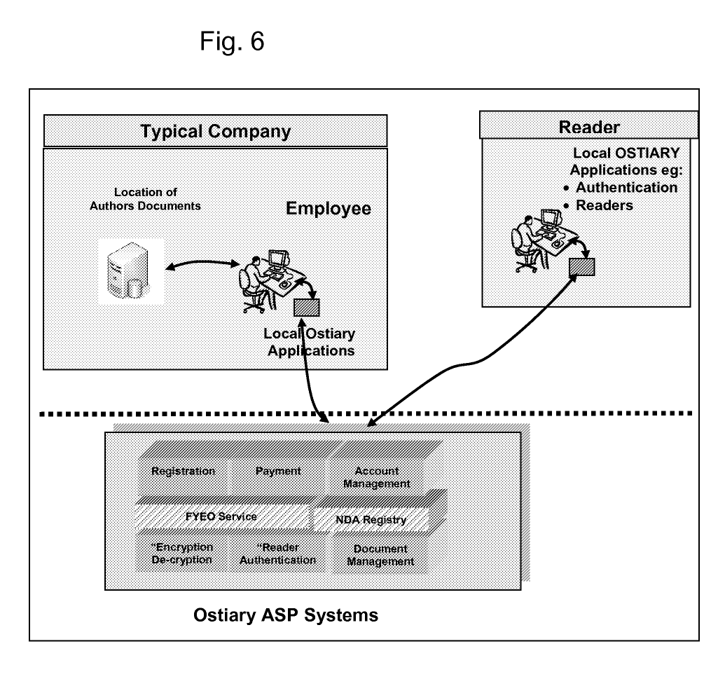

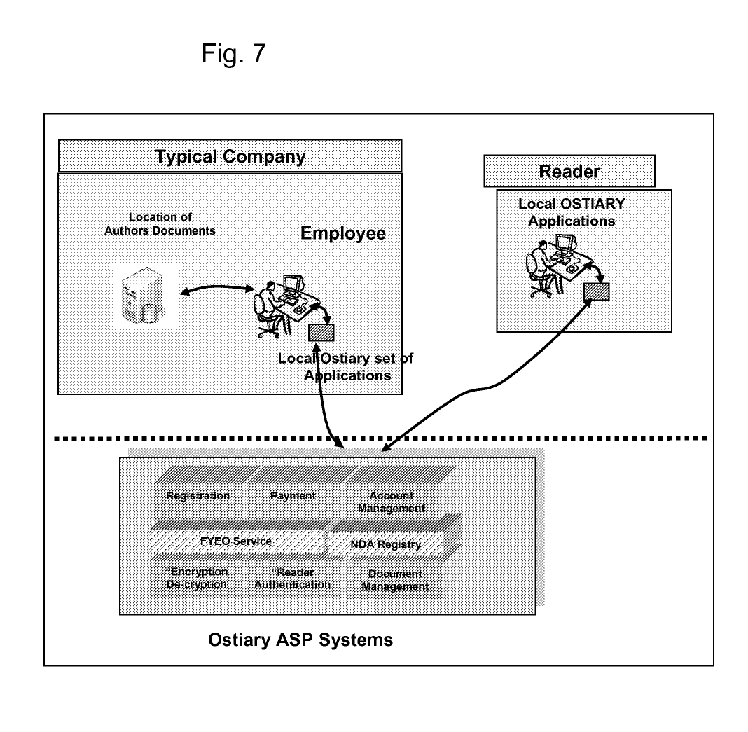

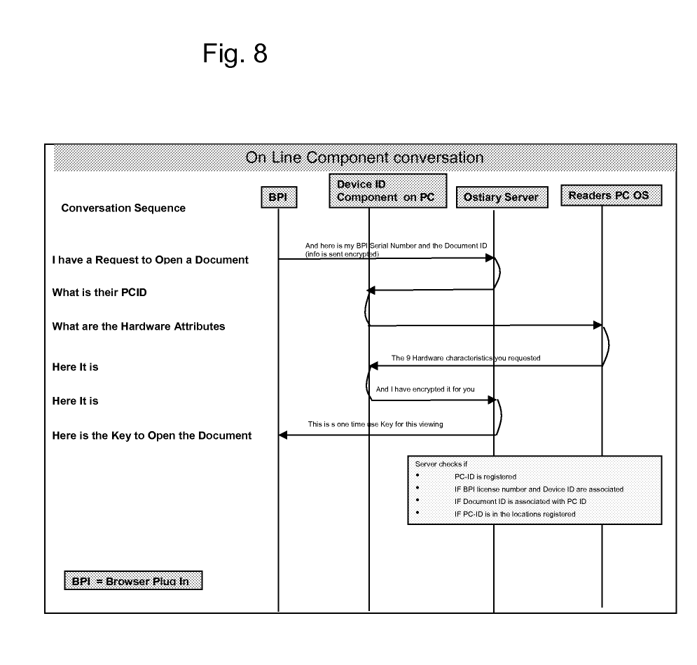

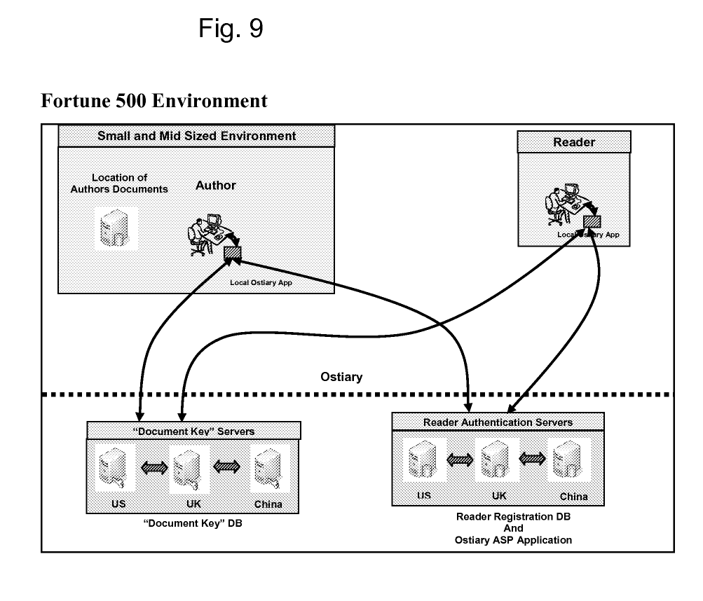

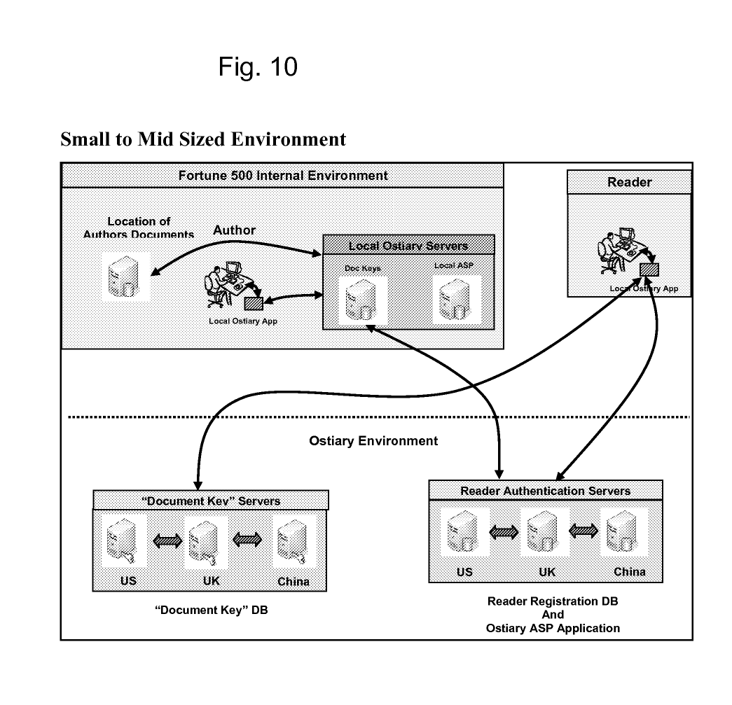

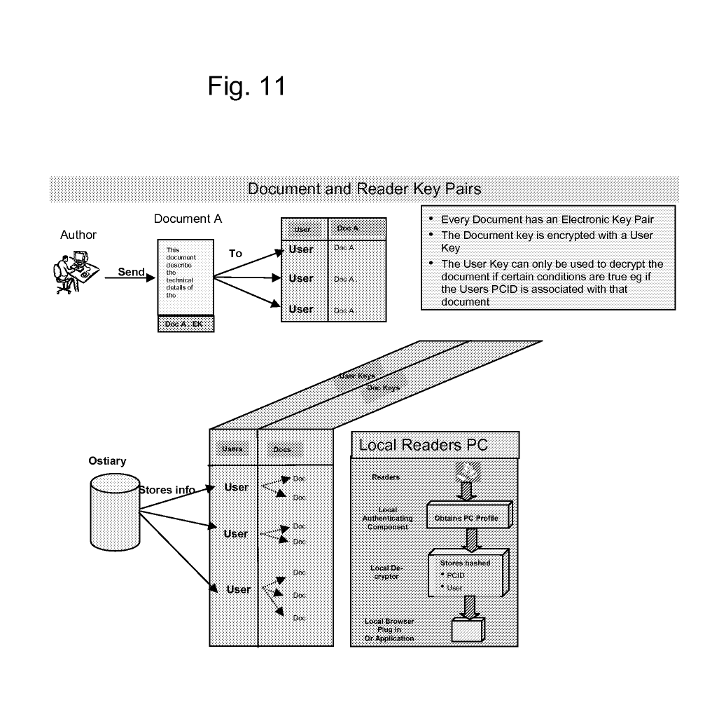

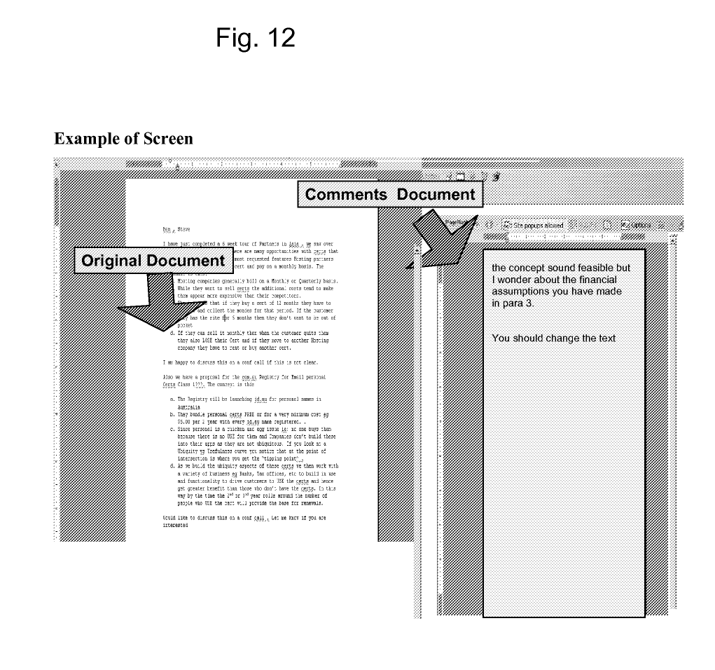

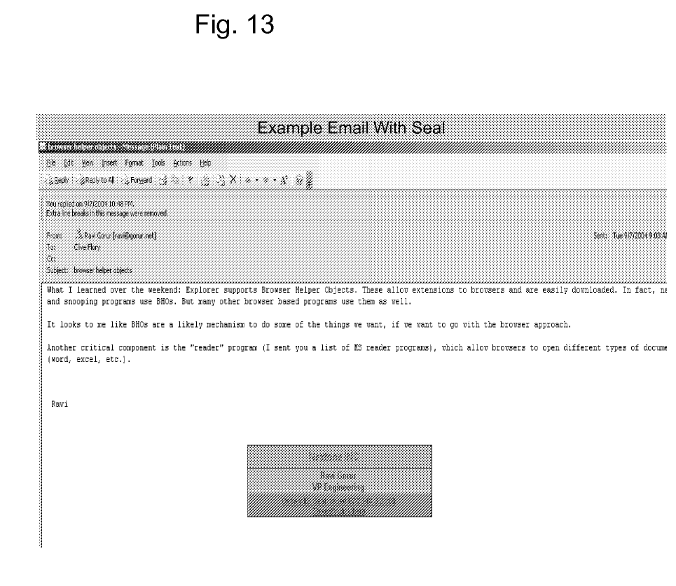

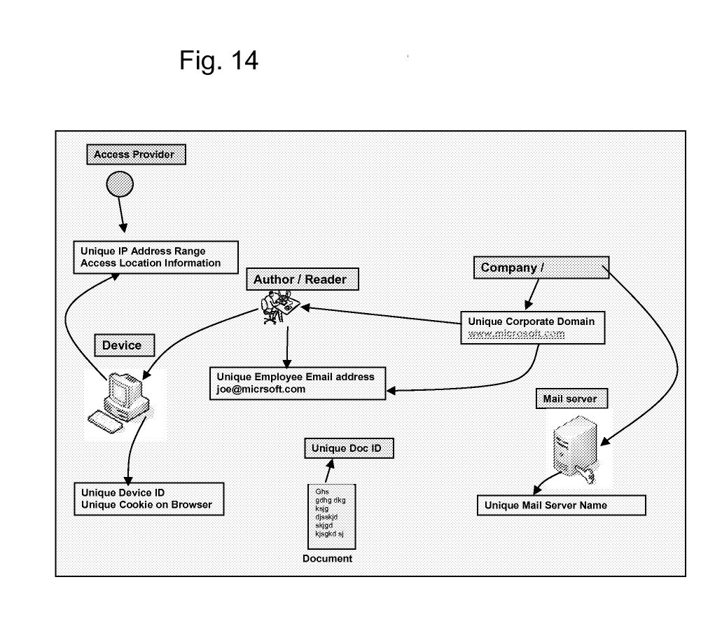

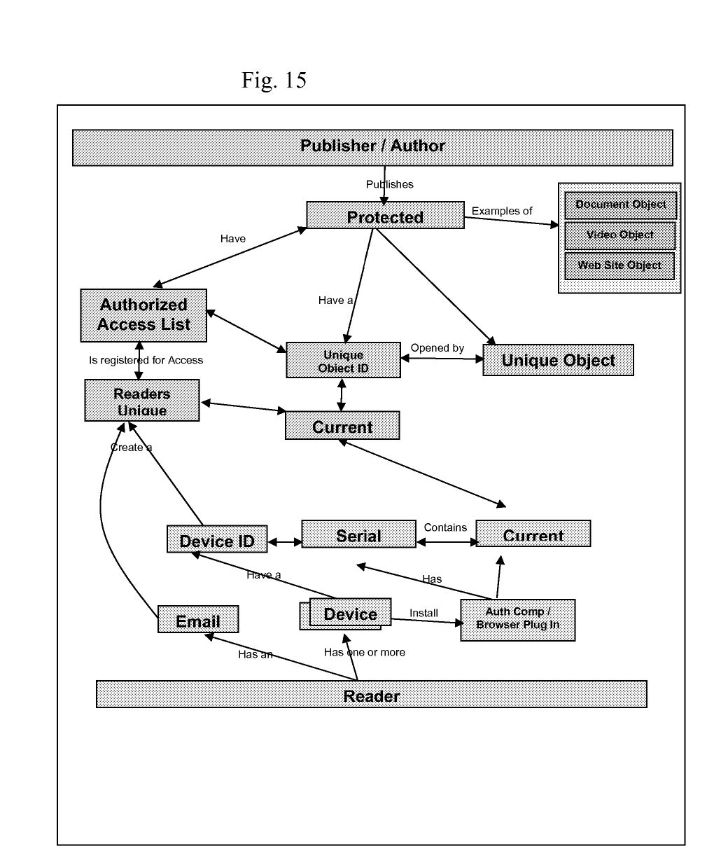

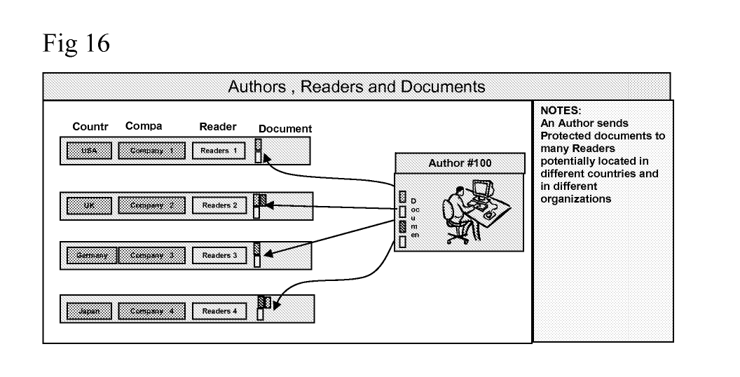

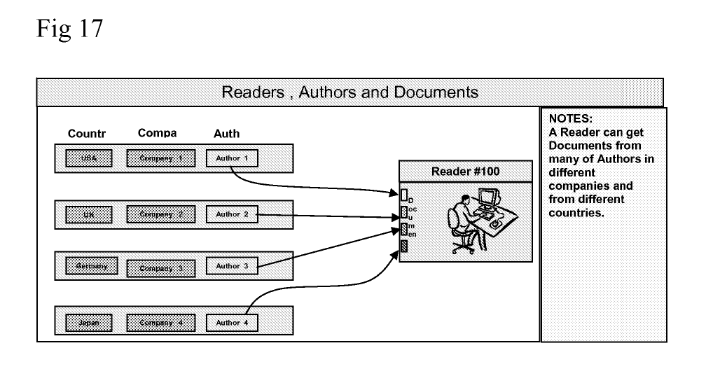

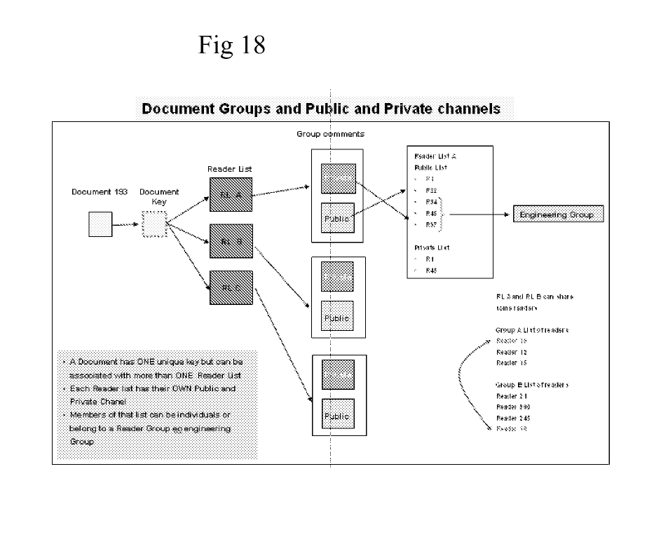

FIGS. 1-3 show the overview of the system. FIGS. 4-8 show the details of the components of the system. FIGS. 9-18 show some applications, examples, and details of the system. The details are described below.

Our system, the subject of the current invention, the Ostiary ASP, delivers the following services through the web:

Document Services:

1. Allows the safe and secure sharing of documents of all common types, distributed by Authors, to an authorized set of Readers defined by the authors.
2. Prevents unwanted copying, printing, or otherwise sharing of these documents by authorized Readers.
3. Allows users (Readers and Authors) to sign documents to provide a mechanism for on-line document acceptance by authenticated users.
4. Allows Authors to track documents through an audit trail. Supports non-repudiation as part of the audit mechanism.
5. Allows Authors to set privilege policies on a per document basis. These include settings for access period, access count, etc.
6. Uniquely identifies every document and provides a simple versioning system. Allows the automatic notification of the availability of new versions to Readers.
7. Allows document annotations and the secure sharing of annotations by authors and readers.
   Definitions:
   Users: All users of the Ostiary system are registered, identified by email address and password and have at least one associated PC/device ID . The Ostiary client must be installed on the registered user's device(s). Ostiary associates the user with this device(s). The Ostiary Client is capable of providing all (or some) services.
   Ostiary Browser Ostiary Client (OBP): A special browser based program that delivers all document services to Authors and Readers.
   Ostiary Password: All access to the Ostiary system requires a password. Ostiary Documents: documents of all common types (Word, Excel, PowerPoint, HTML and PDF) identified, encrypted and specially packaged by the Ostiary System for restricted access by a Reading Circle.
   Accounts and Account Holders: Registered Users with subscription services (those that require payment) belong to accounts and are Account Holders. An Account may include multiple registered users. An Account has billing information (name, address, etc.). The Registered User that opens the account is automatically the administrator of the account and can add/delete other Account Holders.
   User Roles: A Registered User is capable of the following roles.
      Author: A role restricted to Registered Users that are Account Holders. An Author has publishing and signature privileges. Publishing allows authors to secure documents through Ostiary encryption and distribute the document to any number of authorized Readers (see below). Signature privileges allow authors to sign documents.
      Reader: A role for Registered Users that may or may not be Account Holders. A reader has the privilege, assigned by an Author, to view a document.

Note that an Account Holder may be an Author and/or a Reader.
Reading Circle: The group of people with authorized access to one Ostiary Documents (for simplicity at this point, we will assume one document per Circle, but it can be more than 1 documents.). The group is comprised of one Author and zero or more Readers admitted by the Author to the circle. The author determines the privileges for document access by readers. Note that a user who is an Account Holder may play an Author role in one Reading Circle and a Reader role in another Reading Circle.
Authenticated Users: Ostiary will validate registered users on every access to the server; i.e., this is the on-line state of a registered user that has access to system services (document protection, etc.).
   The System Supports the Following Setups:
1. Setup
   a. An Ostiary Server (PC).
   b. Two or more Ostiary User-Devices running Windows.
   c. One PC, running Widows, used as the Author's User-device. This device is pre-loaded with the Ostiary Browser Ostiary Client and connected to the server via a LAN. The Author has been registered into the Ostiary system.
   d. Two PCs, running Windows, used as Readers' devices, connected to the server via a LAN. One of these devices is not registered into the system (no Ostiary Plug-in). This is the Target Reader. The other is registered: this is the Invalid Reader.
2. Author prepares the document through the plug-in
   a. The Author logins into Ostiary, through Explorer/plug-in.
   b. A document on the Author-device is selected for preparation
   c. The Author follows a wizard driven process to prepare the document
      i. The Target Readers is defined with email addresses (one reader is entered)
      ii. The Document security settings are set (non-operational)
      iii. The prepared document is saved
   d. The prepared document is emailed to the target reader (this reader is NOT registered).
3. Target Reader (not registered), saves document from email. He opens the document (must be connected to the server).
   a. Explorer is invoked. The browser notifies the user that the Ostiary Ostiary Client is required and must be downloaded from a specific location (server).
   b. The user downloads the browser plug-in.
   c. The Ostiary Client then uses a wizard process to take the user through the registration process including password.
   d. Once complete, the Ostiary Client gets the document key from the server and allows the Reader to view the document.
   e. The Reader will not be able to cut, copy or print the document.
4. Invalid Reader
   a. The Target Reader forwards the document (encrypted) to the Invalid Reader (who is already registered).
   b. The Invalid Reader opens the document.
   c. The Ostiary Client immediately warns the user that he is not authorized to view the document. The Ostiary Client also asks the reader whether permission from the Author should be obtained. The Reader responds with a “yes”.
   d. The server delivers an email to the Author with the request to authorize the new Reader.
   e. The Author Responds to the email with a Yes.
   f. The Invalid Reader is delivered the Keys to allow him to view the document after password entry.
      Document Requirements

Prepared documents have the following properties:
1. HTML formatting/wrapper
2. Document image clear-text is encrypted and embedded within the wrapper
3. Embedded document image is uniquely identified. This is sent to the server by the plug-in.
4. Image (document converted to image)
   a. Includes “Powered by Ostiary” Header, timestamp, author, etc.
   b. Includes watermark, under control of Author (HTML background)
      Ostiary Client Requirements

The Ostiary Ostiary Client performs the following functions for all users (Authors and Readers)
1. Registration of the user: this establishes the device/user linkage.
2. Password protection for Ostiary document viewing and server access
3. View user information delivered from server on web pages
4. Tool bar for document viewing and preparation (authors)
5. Document viewer:
   a. Page up/down (tool bar buttons and keys)
   b. Support for scrolling with scroll wheel and up/down arrow keys
   c. No Cut/Copy functions
6. Annotation capability
7. Disable Browser Print operation
8. Author Specific requirements
   a. Document preparation (wizard)
   b. Document control: disable, add users, etc.
      Document Services

Document services are initiated by Authors and spread to the Readers within a Reading Circle. All services around a document require an Author.

### Overview of Document Services

Protection and Distribution

Document protection and Distribution is Delivered as Follows:

1. Preparation phase:
   a. An Author prepares a document through the Ostiary Browser Ostiary Client (OBP). This operation requires login to the Ostiary Server and authentication (must be connected to the Inter/Intranet).
   b. The Author defines the Reading Circle: the Author is the first and default member. Readers are included by the author listing their email addresses with one of the following mechanisms:
      i. Typing in the list of specific addresses via a web-page on the Ostiary server. Optionally, the user may type a domain address which allows all Users with the domain address access.
      ii. Picking from an Author pre-defined list of Reading Circles on the server web-page.
      iii. Passively collecting a list of email addresses from the “To:” field on an Outlook email with the Ostiary Document attachment: this will require a special Ostiary Client on Outlook.
      iv. Other mechanisms.
   c. The Author defines if this is a new version of an existing document.
   d. The Author defines document privileges in the Reading Circle (associated with the document):
      i. Printing: No by default
      ii. Cut/Copy: No by default
      iii. Days of access: unlimited by default
      iv. Off-line mode: No by default
   v. Annotation Mode:
      1. No Annotation (default)
      2. Author only: author receives all annotation entered by Readers, not viewable by Readers (except that the originator can view his annotation).
      3. Full Circle: all members view/edit annotation.
   e. The document is stored in some location desired by the Author. Optionally, the Author may define a link that points to the public location of the protected document (a document server) for use during versioning.
2. Once preparation is complete, the author may send the prepared document by email to the Reading Circle. Any user defined in the Reading Circle as a Reader will be given access to the document once the Reader has been authenticated by the Server when the user trust to open the document. The User/Reader must be connected to the Inter/Intranet and login to the Ostiary service for the authentication process.
3. Any additional users included on the distribution list, initially or later, will require an additional authorization step by email, as follows: if a user, not in the Reading Circle, attempts to view the document:
   a. The Server initially denies access to the user, indicating that the Author must allow access
   b. The Server sends an email to the Author requesting that the user requests to be a Reader (i.e., part of the Reading Circle)
   c. The Author accepts or declines the user into/from the Circle, via a response to the email (clicking “yes” or “no” link)
   d. The Authors decision is forwarded to the User requesting access. If accepted into the Circle, the Reader may access the document.

Note that Ostiary does not store the document on the server. All encrypted documents are stored by the user.

Document Services

The following services are provided on a per document basis.

Versioning:

1. Each document is identified with a unique fingerprint (digest). Ostiary allows the Author to define document versions based on the unique fingerprint.
2. When on-line Readers access an old version of a document, they are warned by the system that a new version is available. The system will provide the user with a URL where the NEW version can be downloaded .
   Annotation:
1. The Ostiary Client allows the users in the Reading Circle to add annotation notes alongside the document.
2. The annotation is collected and displayed to the Author or all members of the Circle by the server. The server performs the annotation information exchange; therefore, online access is required to retrieve annotations.
   a. Is offline annotation entry allowed? Yes.
   b. Are annotations securely stored and transmitted? Yes.
3. The display of annotation is through an Ostiary client (desktop or browser based). Annotations are location sensitive: they are associated with a particular cursor position in the document. They are displayed on a per-page basis. Entry is through a third smaller text entry field.
4. Once saved, annotations are transmitted immediately. The server stores and forwards the information.
5. Annotations may be deleted/modified by users who enter them. Thus the server presents the “latest” version of comments. An audit trail is not maintained. Watermarks and other overlays can also be used.
   The Ostiary Client

The Ostiary Client can be expressed as a desktop application written in any language as well as a Browser plug in or a Ajax based client. It provides all services to the Author and Reader. Regardless of method of construction the Ostiary Client provides the following
1. Registers Readers
2. Authenticates users with Server support .
3. Encrypts and prepares documents with server support.
4. Decrypts and digitally protects documents.
5. Prevents cut/copy and print (as configured)
6. Allows entry and viewing of comments, responses and annotation
7. Allows signature operations

The Ostiary Client creates multiple frames. The annotation and document view frames are operated with a single scroll-bar. Annotation entries are identified by users.

The Ostiary Security Infrastructure:

The Ostiary Security Infrastructure contains 5 logical Pillars that act as the foundation for all current or future services. The five pillars are:

TABLE 1
The five pillars.

| Pillars | Description |
|---|---|
| Secure and Share | Secure any document and safely Share |
| | it outside your firewall |
| | (supports Microsoft Word, Excel, |
| | PowerPoint, |
| | Project, and Visio. Adobe PDF, |
| | AutoCAD, TIFF, JPEG) |
| Review and | Gather, Review, Comment, Respond |
| Comment | and Approve Comments |
| | in real time |
| Track and Audit | Know WHO opened, forwarded, |
| | commented on WHAT |
| | documents and WHEN |
| Manage and | Manage and control Readers rights |
| Control | and privileges at ANY |
| | time |
| Sign and Approve | Digitally sign and approve documents, |
| | comments, actions |

These five pillars enable Ostiary to customize and target multiple solutions and market segments using the same underlying components and platform.

The Ostiary Dashboard—provides full Audit Trail of who did what and when:

The Ostiary Server is aware of all events that take place around a document. It knows who created a document, who received it, who opened it, when it was opened, how many times it was opened, when an unauthorized access was made and by whom, who commented, who has not, how many responses have been received, who has signed, etc. In this way, Ostiary constructs a detailed Audit Trail of all events, and provides this information to users via a Dashboard accessed from any Browser.

Full Audit Trail and Visibility:

This FedEx Tracking System capability provides a user with complete visibility of where a Digital Object is. Similarly, the Ostiary System provides the Author with complete visibility as to who received, who opened, who printed, who commented on a document

The Following are the Key Service Offerings:

Document Security—Securing any document outside as well as within the corporate firewall.
Document Audit and Compliance—Maintaining an audit trail on document events (WHO opened, printed or commented on WHAT document and WHEN).
Secure Collaboration—Gather, review, respond and approve comments from a group of people (colleagues, customers, business partners, suppliers) in real time, anytime, anywhere.
Document Approvals and Digital Signatures - Automating the signature and approval process on documents such as: NDAs, HR offer letters, Purchase Orders, Procurements and other legal agreements.
Secure Discussions Blogs—The ability to create a topic or discussion, invite a group of participants and ensure that the discussion is secure and without the headaches that Email provides.

Ostiary is addressing a market where the users are dispersed throughout the world and rely on multiple devices to communicate and stay in touch. Ostiary has designed the service such that users will be able to receive critical comments, respond to comments, sign and approve aspects of the document from any device, regardless of where they are. Devices supported are wireless devices, such as Blackberry and Wireless PDAs.

There are two KEY participants in the model:
Authors—Authors initiate the process by sending Readers secured documents, and determining their Rights and Privileges : Life of document, Comments required, Printing, signature required, etc.
Readers—Readers receive documents with their level of access having been determined by the Author.

Authors subscribe and PAY for the service while Readers use it FREE. Readers have to go through a “one time” registration process. Once registered in the Ostiary Global Authentication server, they will be able to open secured documents sent to them by ANY subscribing author.

The Main Purpose of the Service and System:

The main purposed of the service and system is twofold:
to provide continued authorized access to a digital Artifact such as a digital document in an Open Digital environment
To provide the Access through an Internet based Authentication Method
   Authorized Access

While the thrust of this document focuses on the authorized access of Digital Documents the principle and goals of the design is to provide the authorized access for a range of digital artifacts such as
Digital Documents in any format (e.g. word, Excel, PDF)
Music files in any format such as MP3
Video Files in any format such as MPEG
A Web Site e.g. access to your bank, your Distributors Intranet
A Image on a Web site
To a Physical Building whose locks are connected to the Internet
   Authentication Method and Infrastructure

While the thrust of this design document focuses on the Authentication method in conjunction with the Document Access service the design of this component will be as a stand alone system that can be used by 3^{rd} party vendors for authenticating user access for their own digital artifacts. Examples would be
Adobe using the Authentication method and infrastructure for PDF documents
Sony using it for managing the access to their Music files or Video files
   General Design Principles

Apart from the Business functionality required a key part of the design is to ensure that the system being built
a. Scale to accommodate growth in users
b. Perform well and within Service Levels set down
c. Be Reliable such that the service can be provide with a minimum of 99.99% availability
d. Be Extensible to enable quick, dynamic changes to the components in the system as functions change (to extend or remove unwanted functionality)
   The Ostiary System(s) Overview:

The FULL Ostiary Service is delivered through a collection of Systems, Sub Systems and Components.

The following is a brief description of the systems: Table 5:

| System | Description |
|---|---|
| The Authentication | The Authentication System is the central registry for ALL |
| System | Readers and provides the full Authentication service based on |
| | the unique Digital ID generated from a composite of elements |
| | for each Reader |
| The Subscriber | The Subscriber Registration system manages the Customers |
| Registration System | Registration and Subscription process and also the Authorized |
| | Senders Registration. |
| The Object/ | This is the system that |
| Document | Registers the Document |
| Management | Enables the Policy, Access and Usage rights to be |
| System | established |
| | Provides the Version Control capability |
| | Provides the Document Commentary capability |
| The NDA System | The NDA System enables two or more Companies to |
| | Register a hand signed NDA document between the two |
| | parties |
| | Digitally sign and register the Agreement |
| | Search features |
| The Legal Signature | This is Service as well as a sub system that enables two or more |
| System | parties to digitally sign a legal document on line. The NDA |
| | System also uses this sub system |
| The Billing System | This system handles all the requirements relating to billing a |
| | Customer |
| The On line | This system handles all the requirements relating to enabling |
| Payment System | customers to pay on line a Customer |
| The Reporting | The Reporting System manages all the Reporting needs across |
| System | all the services |
| The Customer | The Customer Service system manages all the Customer care |
| Service Systems | requirements such as |
| The Notification | This is the system that handles all the notification and |
| System | communication needs between |
| | Customer and Systems |
| | Customers and Readers |
| | Readers ad Customers |
| | Notifications can be via |
| | Email |
| | SMS Messages |
| The DNS System | This is a system outside of the Ostiary set of Systems where |
| | domain names are registered with all their related information |
| | such as Name of Registrant, MX Records, Server Records etc. |
| | This system is run by the Registries such as Verisign, Neulevel |
| | etc |
| The IP Geo Location | This is a system that provides IP based Geo location information |
| System | on where a person or device is at the tine they are accessing the |
| | Internet. This system is provide by Digital Envoy |
| The Reader System | This is the system that enables the Reader to make a request to |
| | access a document and interfaces with the authentication |
| | systems and controls the policy and usage at the Reader end. |
| Referral System/ | This system provides the ability for Readers and users to refer |
| Tell a Friend | the service to others |

Each of the Systems has Components that perform some task and communicate with each other. Some components can be part of more than one system. And system relate to other systems.

When components communicate there is a standardized format for communication. Every component can communicate but every component responds only if there is a threshold reached that triggers its response.

Following is a detailed description of the systems with respect to the
Components in the systems
What the systems do
How the system works (the Processes)
The Communications between components and system

### Detailed Description of the Ostiary System(s)

The Authentication System

The heart of the Ostiary Services and systems is the Authentication Systems, whose main purpose is to ensure that authorized access is honored.

What is the Authentication System

The Authentication System is a central registry of Readers who are authorized by Senders to access and read Ostiary processed Digital Objects such as documents. The Readers go through a Registration process where
The Reader
Their email address
the device(s) that they want to use for access and
The IP Geo location of the Reader
Fingerprint

are linked to form a personal “Composite ID” or “digital fingerprint”. This digital fingerprint becomes a representation of the Reader, and once this is done, then they can access any digital object from ANY Sender using a Reader appropriate for that Document.

What are the KEY Elements and Components?

The key elements and components are
The Readers Details
Their email address
The Device characteristics
Their IP Geo Location at the time of Registering
Their Biometric details
   How is the Authentication Process Started

The Authentication process is triggered starts when
Self Register Process: A Reader goes to the Ostiary Web site to “self register”
Trying to Read a Ostiary Document for the first time Process: The Reader tries to open an Ostiary document for the first time
   The Self Register Process

A reader can be sent to the Ostiary web site a number of ways . When the Reader gets to the web site there will be a section called Reader Registration.

When the Reader clicks on this link they will Get a Reader Registration form: “Insert Reader registration form”.

The Core System

At the heart of the system are a set of Unique Identifiers for a number of Objects that are captured and related in a way that creates the Authentication system.

The Key Object IDs captured are:

TABLE 6

| The Object | ID Types | Description | Example |
|---|---|---|---|
| The | Document ID | Every Document has a unique ID | Hhy673b7b33bbd |
| Document | | that the system generates | |
| The Reader | Email Address | Every Reader will have a business | bill@microsoft.com |
| | | email address given to them by | |
| | | their company | |
| | User Name and | As in most login registration | |
| | Password | systems there will be a need to | |
| | | capture a users | |
| | | User Name and | bgates |
| | | Password | Linux |
| | Users Unique | The system will have a set of | |
| | Question and | questions that require a response | |
| | Responses | that only the Reader will know. | |
| | | Examples are | |
| | | What is your mother's maiden | |
| | | name ? | |
| | | What is the city of Birth ? | |
| Device | Device ID | A Reader can have one or more | Kjks873buf8u8ur8 |
| | | devices to read a Document. Each | |
| | | Device will have a unique ID | |
| | | generated form the Device IDs | |
| Client | Application Serial/ | Every application installed will | HYH 88U HJ3 |
| Application | License number | have its own Serial/license | Y6Y JJY |
| | | number hat will be recorded | |
| Session | Session ID | Every time a Reader has to access | I84u8uj8ur jk8 |
| | | to Ostiary Server a session is | |
| | | initiated | |
| Geo | Geo Location ID | Every time a Reader accesses a | Country = |
| Location | | document they and their device | State = |
| | | are in some location. The exact | City = |
| | | location is unknown but the | |
| | | location of the devices Access | |
| | | point via their ISPs can be known | |
| | | to some degree | |

Each of the IDs that is generated are either
Fixed, i.e. a Document ID NEVER changes unless some element of the document changes
Changes, i.e. when ever a new session had been initiated

Furthermore every ID is associated and related to one or more other IDs in some way The table below shows which IDs are Fixed, which IDs Change and Which IDs are associated with which IDs. This table forms a key part of the authentication system:

TABLE 7

| ID Type | ID Example | Fixed/Changes | Associated with |
|---|---|---|---|
| Published | Hhy673b7b33bbd | Fixed | Readers Email |
| Objects ID | | | |
| Readers Email | bill@microsoft.com | Fixed | Object ID |
| ID | | | Device ID |
| Device ID | Kjks873buf8u8ur84 | Fixed | Readers Email |
| | | | Serial number of the App |
| | | | Cookies placed on the Device |
| | | | IP Location info based on location of |
| | | | App |
| Application ID | HYH 88U HJ3 | Fixed | Device ID |
| | Y6Y JJY | | |
| Session ID | I84u8uj8ur jk8 | Changes | Device ID |
| (cookie) | | (when Reader | |
| | | makes request | |
| | | to access a | |
| | | Document) | |
| Location ID | Country = | Changes | Device ID |
| | State = | (ONLY when | |
| | City = | the Readers has | |
| | | physically | |
| | | moved their | |
| | | location of | |
| | | Internet access) | |

The Core Process

The Publisher authorizes a Reader to have access to a set of objects by associating the Objects ID (e.g.: Doc IDs) with the Readers email address.

To get the keys to open the document a Reader has to
registers with the Ostiary Authentication system
Download the Reader Plug Ins

When a Reader Registers the process goes through the following steps
Requests Reader to enter basic Reader information
   Name
   Position (optional)
   Email address to be used
   User Name
   Password
   Select Question
   Provide response

Once this is done, the system sends the reader a confirmation email with a URL The reader has to click the URL to complete the registration process When the URL is clicked the Reader is taken to a Web Registration completion page, at this stage the System:
Grabs Device Information from the Reader such as
   Processor ID
   Computer Model
   Mac address
   Etc
And generates the Device ID
It then Links the readers Email with that Device ID
Asks the user to NAME the device (Work PC, Work Portable)
It then downloads the and Installs the Reader Application on the Readers device
It then Links the Applications Serial number with the Device ID
It hen grabs the IP Geo Location of that Device and Links the current IP location with the Device ID
It Places a cookie with the Device
Links the Cookie ID with the Device

When a Reader wants to access or Read a document the following steps occur:

Step 1

The Ostiary set of Applications send the following data elements from the device to the server
The Application serial number
the Cookie ID from the Device
the object ID or Document ID
IP location data
   Step 2

The server verifies that
a. the App serial number is indeed associated with that cookie
b. the IP location data is also associated with that serial number

If YES then it proceeds to Step 3

If NO it
Terminates or
Requests that the Reader go through a re-authentication process.

NOTE: If the IP location data is different as in the case when the Reader is traveling we will have a process to accommodate this.

Step 3

The Server now checks to see what Device ID is associated with the Cookie and App serial numbers submitted.

Once it determines this it then:

It checks to see what email addresses are associated with this device ID.

Once it Determines this, then:

If then pulls up the list of Object IDs associated with this email address,

It then checks to see if the Object ID sent to it by the Reader is on that list.

IF Yes:

It then sends the Object KEY to the Device in encrypted form.

ANTI-Fraud Detection

There are many methods we will use to detect fraudulent access
a. We will look at the location IP data and determine probabilistically if there is a Fraudulent attempt to access or not
b. Random requirement to re-authenticate

A hacker can copy the serial number and cookie information and install this on another devoice. This means that two or more Device with the same serial number and cookie can request access to the same document.

So the ONLY way around is for the system to randomly and automatically generate the Device ID and send this along with the Serial Number and Cookie info to the server.

In this way a hacker will only be able to get unauthorized access for a limited number of views.

Once a hacker's device has been identified we place them on a black list.

A Component View of the Systems

Location of Components

The key systems and their components are potentially located in 4 areas.
a. On the Senders Local PC
b. On the Readers Local PC
c. On the Ostiary Service Platform in the Ostiary Data Centers
d. On some server inside the Senders Organizations firewall (this is an option, and not mandatory)
   The Key Components List

The system contains the following major components

Ostiary Server Side Components

TABLE 8

| Components | Brief Description of Components Service |
|---|---|
| Subscription | This component manages and provides the following services |
| | Subscription Service |
| | De-registration Service |
| | Renewals Service |
| | Aspects of the system |
| Registration | This component is a subset of the Subscription component as |
| | it manages and provides service during the Registration and |
| | DE-Registration process ONLY |
| | all aspects Manages the registration and de-registration |
| | functions of |
| | Companies |
| | Authors |
| | Readers |
| Service | When Users register they select a service. This component |
| | contains all the necessary functionality to enable users to |
| | select |
| | change |
| | upgrade |
| | The service they have requested |
| Service Levels | Determining what type of Service the user has |
| | registered for ensuring they get the right service |
| | There are various TYPES of Service and there are |
| | various LEVEL of Service |
| | User can select the levels of Security service |
| Policy | Every document has none or some restrictions on |
| | Who can access or view the document contents |
| | What functions are available |
| | How long can it be seen for |
| | The Document Policy component enables a Author to set these |
| | restrictions or constraints |
| | Examples of Policy settings are |
| | Disable Print |
| | Disable Save |
| | Life of Doc is 7 days |
| | Can be opened only 3 times |
| Billing | This takes care of the billing issues between Ostiary and the |
| | User |
| | Billing has to be a plug in as a 3^{rd} party vendor might want to |
| | private label the service |
| Payment | Needs a Payment mechanism for users to pay online |
| Document Preparation | This component manages the process of preparing a document |
| Component | for the FYEO service. This component does the following |
| | Scans Doc for Viruses |
| | Encrypts |
| | Places doc in a location |
| Server Side | For a Reader to gain access to view the contents of a |
| Authentication | document they first have to be Authenticated prior to |
| | authorized access |
| | See The Authentication Process |
| Server Side | Every Document that is sent is encrypted |
| Encryption/Decryption | The key to Decrypt is sent only after the Authentication |
| | process from the server or locally |
| Digital Keys | All protected Digital Objects like Documents will be |
| | encrypted with a digital key and Readers require these keys to |
| | gain access |
| Notification | Any notifications sent or required by subscriber |
| | Notifications are either in Email, SMS message etc |
| Email Plug In | This is the plug in used to activate the Document preparation |
| | process |
| Manage Customer | Manage all the Address, and contact details |
| details | |
| Account Details | A tool to enable the end user to mange their Accounts |
| | Name |
| | Address |
| | Payments |
| | How many documents have I used |
| | Upgrading my service level |
| Document | What documents have I prepared |
| Management | How many have been sent |
| | WHO have I sent them to |
| | How many have been opened |
| Version Control | Provides all of the Version Control Functionality |
| Document | Provides all the Document Commentary functionality |
| Commentary | |
| Communication | This component manages the communication and messaging |
| | between the Authors, Readers Apps and the Ostiary Key |
| | servers etc |
| Virus Scanner | This is the component that simply scans the document and |
| | says if there is a virus or not |
| | It does not remove the virus |

The Readers Client Side Components

The Readers have to install some application and components to enable the system to work.

TABLE 9

| | |
|---|---|
| Local | This is a component that sits on the Readers PC. Its main task is |
| Authentication | to gather the PC hardware profile to generate the Unique PC ID |
| | and or to communicate this information to the Ostiary Server |
| | and Local Decryptor Container |
| Local De-Cryptor | The Local DeCryptor Component manages the following |
| | the local document keys |
| | the decryption of the keys |
| | communicates to BPI |
| | Stores the Readers Password in secure format |
| | Stores the Local PCID |
| Browser Plug In (app) | This is the application that is installed by the Reader on their PC |
| | device The component is evoked when a Reader wants to read |
| | an Ostiary document, It communicates with the Ostiary Server |
| | to determine if the User is Authorized. This can be expressed as |
| | a desktop stand alone application or as a browser based |
| | application |
| The Local | The Local Application is different to the BPI |
| Application | This is a full featured Light Weight Application that provides a |
| | higher grade of protection than the BPI does |
| | This component also enables the Author and Reader to manage |
| | all the Ostiary related documents |

### Detailed description of the Components

The Reader Components

There are two ways a Reader can Read a document
e. Using the Browser Plug In component
f. Using a desktop Application
   The Browser Plug In Component (BPIC)
   Description

The BPI is a component that is installed by a Reader to enable them to view and comment on a document while using Internet Explorer, Firefox, other browsers, etc When the BPI gets registered it is associated with the document type that Ostiary creates (after encryption)

So when an Author sends an Ostiary prepared document to a Reader the act of trying to open the document invokes the BPI

The BPI
Is invoked when a user tries to open an Ostiary prepared Document
Communicates with the Ostiary authentication servers to
   request the Document keys
   Pass any cookie information
Uses the key to open the document within an IE browser
provides the Comments functionality

NOTE : The BPI is ideal for and used primarily where the Reader only requires Read functionality and not Author functionality. If the Reader is also an Author then the OLA would become the client they would use to read and comments on documents.

WHERE can a Reader get the BPI:

The BPI is a component that can be downloaded from any participating Site. Most likely the primary site will be the Ostiary site. But companies that subscribe to the service can have the BPI downloaded from their site or have a link from their site to the Ostiary download site.

The Ostiary Local App (OLA)

The OLA is a application that is used by Authors who are also Readers. As such they perform all the functions of the BPI Component plus have all the functionality required by the Author. The app is installed by the Reader when they register. Like the BPI it also is associated with the Ostiary document type. The act of trying to open an Ostiary file will invoke the OLA.

The OLA however has a built in Browser view component so the document is viewed in this browser component and not IE.

The OLA provides all the local functionality for
a. Selecting files for Publishing
b. Submitting files
c. Viewing files
   Additional Functionality

In addition to the functionality of the BPIC the OLA has a management component. NOTE: In the ASP environment most of the management functionality will be provided from the server side. But in large corporate environments the OLA would replace this but still have communication to the server to send and receive data.

Digital Keys:

Digital keys will be used to ensure that encrypted information can only be opened by authorized users.

The system uses digital key Pairs in a number of areas.
a. Key pairs for Every Document
b. Key Pairs for Every Reader
   Digital Keys for Documents

While Every Document has a Unique ID, they also have a set of unique key pairs. These key pairs are used to encrypt and decrypt a document. These unique key pairs are generated at the Ostiary Server at the time of preparing the document for FYEO publishing. An Enterprise deployment might have the Digital Key generation performed at their site.

The two key pairs for every document are
a. The Encryptor key
b. The De-Cryptor Key

The Encryptor Key encrypts the document prior to being published and sent to Readers.

The De-Cryptor key is:
a. Sent WITH the document to the Readers and stored on the Readers Local PC for de-crypting OR
b. Stored on the server and used ONLY when the Reader is on line

NOTE: The system will enable an Author to set the rule
a. Let the Reader open the document Off line or On Line
b. The Reader can ONLY read this when On line

The decrypting key is activated when the accessor has been correctly authenticated

Associating Documents with Keys

When a document is readied for publishing the document and its associated details (Author ID , Document ID, Document Key etc ) are registered at the Ostiary server. So EVERY Document ID is associated with the Documents Keys When the document is sent to the Readers or when Readers pick up the documents the keys MAY also be registered on the Readers Local PC in the Ostiary Encryptor/Decryptor component on the Local PC.

Therefore, this local component knows which documents are associated with which keys. Local keys are temporary keys for temporary Off Line Access

Rotating Document Keys

The document ID is always unique. Associated with that Doc ID are the keys that are generated to enable a Reader to open the document.

An author can set the system such that every time a Reader access and reads a document the Server sends the Next key pair. In this way the keys used can be on a one time only basis.

The purpose of this feature is to provide a higher grade of security for users that need this.

Alternative Method

The key that finally opens the document is fixed and once generated is for that document. However, the key generated to gain ACCESS to the document key can be rotated.

Where are the Keys Stored

Document Keys are stored on the Ostiary Server on a company's server or locally in a container on the Readers PC. Readers don't have access to these keys so keys cannot be copied or sent to another Reader. These keys are only accessed by parts of the application and under certain conditions.

The keys are stored in the applications directory in the Document and User Key container.

Access to the Keys

A key is accessed when a Reader tries to open a document.

The client asks the question “Can I have the key to open this document”

The PC ID Requestor starts the process by getting the PC Hardware profile.

It gives this to the Authenticator.

The authenticator generates the hash ID for the device and sends it to the Ostiary server or compares it locally.

IF the PC ID is correct the Authenticator lets the Decryptor Component know.

The Decryptor then unlocks the document key and provides the key to the BPI.

Digital Keys for Users

Every user that registers has a unique key that is stored on the server and or their local PC and which is associated and is part of their digital identity.

This key is used as one of the means to authenticate the users and to open the documents.

Users Password

When a Reader registers on the Ostiary server their user name and password is stored on their Local PC in encrypted format. This is used ONLY when the user is off line.

The Distributed Nature of the Document Key and Authentication server

Because the user community will be a mixture of small to large companies there will be need to cater to these groups. There are 3 key components:

TABLE 10

| | The enterprise Secure | Ostiary Secure |
|---|---|---|
| Components | Environment | Environment |
| The Authors Document | Fortune 1000 | SME and |
| | Mid Sized | Mid Sized |
| The Document Key | Fortune 1000 | Some Fortune 1000 |
| | | Small and |
| | | Mid Sized |
| The Reader | | Fortune 1000 |
| Registration Data | | Small to Mid Sized |

As the user base spreads outside of the US then there will likely be a need to distribute the “key” servers to accommodate the markets need.

Knowing WHICH servers to get the Key from

A typical Reader is likely to get Documents from a variety of Authors who potentially can have their documents registered in a variety different authentication servers located anywhere in the world there will be a need at the Readers end to know WHICH Ostiary server to communicate with to get the particular key to open the particular document.

Knowing WHICH Servers to get the Readers Authentication Processed from

ALL Reader registration and Digital IDs can be stored on a central Ostiary managed servers or on servers owned and managed by organizations who may want their own Reader Authentication servers.

When Readers are registered in a different servers to where the document keys are, the local components will be able to find out WHICH server to talk to for Reader PCID validation.

When a document is prepared and published part of the data that is associated with the document is WHERE the authentication and Document Key servers are located.

Document Policy Component

When an Author publishes a document they may want to specify HOW that document is used by the Readers i.e. What constraints they want to place on the document for the Readers i.e. what rights and privileges they grant for the reader

What Document Constraints and Rights and Privileges are Possible

Every document has none or some restrictions that can be imposed such as
Who can access or view the digital objects contents
What functions are available
How long can it be viewed for

Below is a list of possible but not exhaustive list of rights and privileges Table 11:

TABLE 11

| Object | Constraints | Description of Constraints and Example |
|---|---|---|
| People | Access | Who can View the documents |
| Digital | Disable | |
| Object | Print | Disables the Print function within the document |
| | Copy | Disables the Copy function within the document |
| | Save | Disables the Copy function within the document |
| | Screen Capture | Prevents Screen capture to be used |
| | Access | Disable Users access After |
| Object Viewing | Number of | Set a documents Viewing life to |
| | viewings allowed | Number of views allowed = Once only or 5 times |
| | Life of Document | Document exists |
| | | from This Date to This Date |
| | | For a Period on 2 months from this date etc |
| Access | From a Particular | Only people accessing from New York State |
| | Geo location | Exclude any viewing from certain countries |
| | From a particular | Only allow viewing from employees of Proctor |
| | Domain | and Gamble |
| | From a particular Post | |
| | Code | |
| Document | Access at a page | Enable access only for pages 1, 5, 9 and 10 |
| | or section level | Disable access to this section on this page |

The digital object Policy component therefore enables an Author to set these restrictions or constraints.

A Process View of the System

Authors and Readers of the system have to be registered in the Authentication system first to be able to use the security service. They also have to install the Client application that renders the secured object.

Once registered and installation is done then Authors can start to secure objects and invite participants to view the objects

Secured digital objects are made available to Readers by sending it as a file attachment on an email or making it available on a FTP server.

The reader opens the digital object in the installed client using standard Windows OS methods to open the

The secure Object Process

To secure a Object the Author
opens the client app
selects the object to be secured
adds one or more Readers to the authorized list
sets their rights and privileges and constraints
Optionally apply keywords
Optionally apply notifications to the events of the object

When Author submits the object to the securing process the system then
Scans the object for potential viruses
Generates the Document unique ID
Encrypts the Documents
Captures relevant Author details such as Authors email address, PCID et
Creates the Private decrypt key for the document
Registers the authorized list of Readers for that document key
Set the versioning attributes of the object
Send the Secured object to the authorized reader list

The view, read and comment process

Once an Author secure a document the Readers will be notified that they have been invited to view and or comment on the object

To view an object the Reader does the following
a. Registers with the system
b. Installs the client Viewer
c. Opens the Secured object
d. Gets authenticated
e. If the Readers is authorized to read the Object then system provides the access and decryption key
f. and sets their Rights , privileges and constraints
   Reading Off Line or On Line

An Author can enable the Reader to read a document
a. On Line ONLY
b. Off Line ONLY
c. Combination based on Readers situation
   The Digital Object Rights and Privileges

The Author can control two broad aspects of the Objects attributes
The functions available with the object e.g. Print, , Open, copy, paste
The Life of the document (the time period a user has access to the digital object)
The Frequency of access (the number of times a user can access the object twice, 5 times etc)
   Functions of a Document

With any document the system can determine what functions are available or denied.

Some examples are
a. Document can have its Print function disabled
b. Document can disable its copy and Paste function
c. System can disable Screen Print feature
   Life of Documents

The document can be viewed only once and then dies for that user

Document has a life of only n days

Documents used in Web Conferences.

Often a user can do screen shots and take copies.

The Document Tracking Number

Every email that is sent from the system with or without a secure object as an attachment but with a Protection request will get a tracking number

This will be the key number that is assigned to the original email thread

Any subsequent event e.g. if the email is forwarded or replied will generate an extension

Tracking Number Composition

The tracking number will be a 16 digit number in the form 4545.6552.5298,9987

Allowing for a large number of tracked events

Tracking Number Extension

When an email is forwarded etc then number generated will be of the form 4545.6552.5298,9987.1 4545.6552.5298,9987.2 4545.6552.5298,9987.3

Etc

The tracking number is like the Fedex tracking number in that it binds the following
Sender
Recipients
Date and time of email
Document name
Document size
NDA Registry number
   The Life Of A Document
   Purpose:

If a Author has a need to establish the life span of a document for Readers For example
a. For 10 days from date of publishing
b. From Feb. 20, 2004 to Mar 12, 2004
c. For 5 days AFTER a recipient has first opened document

Then this functionality should enable the Author to so

General Principles:

Life Span is an Attribute of

a. CASE 1. The digital object or
b. CASE 2: A digital object AND a USER

Case 1 can accommodate some of the needs of Case 2

If user needs TWO version of a doc with two different life spans they can create TWO versions and place different Life Span for each

When does the Life Span Start:

The user will specify WHEN the Life Span rule starts

The life of the document can start from
a. Date of Publishing Document (regardless if it has been sent)
b. Date of 1^{st} sending Document to a Reader
c. Date of Reader 1^{st} Opening a document
d. Other
   Publishing a Document or Digital Object

What does it mean to Publish a Document or digital Object

A document is not KNOWN to the system until it has been published. This differentiates all Authors documents from Published and un-published

Only a registered user who is also an Author can publish a document.

Document Rights, Policy, Usage

TABLE 15

| Right | Description |
|---|---|
| Full control | In this case the Author has conferred equal rights to the Reader as the |
| | Author has |
| Change | This right enables the Reader to read, edit, and save changes to a |
| | protected document (but not print). |
| Read | This right enables the consumer to read a protected document but not |
| | print, edit, save, or copy or forward. |
| Document expiration | Once set it restricts the viewing window of the document from the date |
| | sent to the date of expiry |
| | A document Expiry can be for ALL Readers or Expiry can be on a Per |
| | Reader basis |
| Print content | This right denies the consumer the ability to print protected content. |
| Allow users with read | This right enables the consumer to read and copy content of a |
| access to copy content | protected document to the clipboard but not print, edit, or save. |
| Access content | This right enables protected content to be accessed by another |
| programmatically | application programmatically. |
| Users can request | This right enables the consumer to contact the publisher at a specified |
| additional permissions | e-mail address to request an upgrade in the rights assigned. |
| Allow users with | This right enables protected content to be read in Microsoft Internet |
| earlier versions of | Explorer through RMA. |
| Office to read with | |
| browsers supporting | |
| Information Rights | |
| Management | |
| Require a connection | This right sets the use license to expire immediately after the protected |
| to verify a user's | content has been accessed. As a result, the consumer must have online |
| permission | access to the RMS server to get another use license every time the |
| | document is opened. |

The Players and Roles Played in the Document Processes

TABLE 16

| Type | Description |
|---|---|
| Admin | Account Admins have total control of ALL keys associated with |
| | an Account. Since all Authors belong to an account the Admin |
| | can remove, assign delete an Authors access to objects keys |
| Authors | They originate a document and OWN the document |
| | There can be more than One author for a document |
| | There is generally a Lead Author of author list is >1 |
| | An Author can be a Reader and a Sender |
| Readers | Authorized Readers receive documents from Authors for the |
| | purpose of reading, making some comments |
| | or editing documents |
| | Readers rights range from |
| | Read Only |
| | Read and make some Comments but not edit a document |
| | Read and Edit text in the body of the document |
| Senders | Senders are not Readers or Authors but on occasion need to |
| | have access to the document to Send the document to others. |
| | Examples are the Personal Assistants of CEO, executives etc |
| | Senders may need reading rights to ensure they are |
| | sending the right document |

A document can be prepared by an Author but Sent by a Sender

A Document can be Prepared by a Sender and Sent by a Sender or Author

System provides a setting that enables
Senders cannot open and view a document
Senders can view a document but once only

Readers are have to be registered and they have to be validated to gain access.

Version Control of FYEO Docs

Often a user sends a document that over time gets revised and updated. The user then sends the revised document out to the group. There are many instances when members of the group use the older version of the document not realizing that the version they are using is one or more versions behind documents are new versions of the prior. The versioning functionality for the system is designed to solve this problem.

How will it Work?

When a user selects a document to protect they prepare that document in the usual way.

One additional function they set is “versioning”

When the user sets this the system will ask the user the following

Who is allowed to change the version of the document? The response will be simply an email address.

Once this is done the user sends the document

Every time there is a new version the sender prepares the document and tells the system that the NEW document is superseding a prior document. In this way the system keeps a trail of all prior versions and a chain.

When a user with an old version clicks the document to view it the agent sends the server the document details e.g. Name of document, Original sender,

The system looks to see if there are any documents succeeding it. If Yes, it sends the user a Web notification:

“The document you are trying to view has been superseded, click here to get the latest version”

In this way the system maintains a thread of the document like a threaded email.

What is the “Authorized Recipients” List

Whenever a sender sends a document there is always zero or many recipients in the list.

If list is zero then the ONLY person that has access is the Author

How does the System know that the user is Authorized to get the Latest?

The system keeps track of ALL the recipients associated with a document

So whenever it tries to enable the viewing of a document it always uses the authorized recipient list.

How is this Created?

Whenever a user sends a protected file the system grabs the following details during the Secure process
Name of Object
The name of the document being secured
WHO it was secured for (the Reader list)
Size of document
PC ID of each recipient (this occurs only when the user registers)
Keywords
Rights and Privileges
Notifications
How it was sent

When the system gets this data it associates this with the particular document key

Document Versioning

This feature enables an Author to ensure that everyone with authorized access will see only the MOST current version.

The Problem Definition

A writer has multiple versions of a document in circulation and wants to centrally and automatically control WHICH document the recipients will read without the need to inform the readers.

Use Case Scenario

Writer Joe sends a draft agreement called “draft proposal 1.doc”. He sends the doc to 10 people via email.

5 open the doc and read it and 5 don't

In 5 days the Writer Joe sends a new version called “draft proposal 1a.doc” to the same 10 people.

In this way Writer Joe could over time publish many versions of the document So as versions of a document proliferate what writer Joe wishes to avoid is a reader opening an older document accidentally and comment on this older document.

Design Concept

Purpose

To build a feature that would enable a writer or sender to centrally manage which versions of a document a reader is able to read and open.

When Writer Joe sends a document as an attachment via email the system registers the document. Every subsequent version is recorded. If the naming convention is such as in the above case then the system would cluster the document together as being part of the same with the user being abele to override this.

Say Writer Joe has sent 3 versions (The original and two updates ) and now wants to ensure that the right version is opened.

Writer Joe would log into the system

System would display Writer Joes list of protected documents (and associated versions) by some category. Below are examples
By Date (Most recent to old)
By Group
By Recipient
Etc

Joe would select the document and all its versions When a user logs on to the system they will get the following:

TABLE 17

| Document Name | Version | Date sent | Description | Current | Recipients | status |
|---|---|---|---|---|---|---|
| Proposal 1.doc | Original | Aug 3^{rd} 04 | Blah blah | [symbol] | John Adams | Opened |
| | | | | | Abraham Lincoln | Not Opened |
| | | | | | Charles Darwin | Opened |
| Proposal 1a.doc | Ver 1 | Aug 6^{th} 04 | Blah blah | [symbol] | John Adams | Opened |
| | | | | | Abraham Lincoln | Not Opened |
| | | | | | Charles Darwin | Opened |
| Proposal 1b.doc | Ver 2 | Aug 11^{th} 04 | Blah blah | [symbol] | John Adams | Opened |
| | | | | | Abraham Lincoln | Not Opened |
| | | | | | Charles Darwin | Opened |
| Proposal 2.doc | Ver 3 | Aug 15^{th} 04 | Blah blah | [symbol] | John Adams | Opened |
| | | | | | Abraham Lincoln | Opened |
| | | | | | Charles Darwin | Opened |

Writer Joe would scroll to the version they deem to be current and mark it

The system would them block all prior versions and provide a message to the user.

What Happens when a User tries to Read an OLD Version:

User will get a message displayed
Message
The Document Proposal la.doc you are trying to open is an older version
The current version is Proposal 2. doc
Sender was Graeme Marsh
Date sent was Aug. 15, 2004
To download the current version click on this link www.companya.com/securedocs/Propsal2.doc

If a file upload area was used a URL link would be generated for such location and be used to enable users to download from.

Process

Background

Reader A receives 4 emails from Writer Joe over a 15 day period with the following docs attached.

TABLE 18

| Doc Name | Date Sent |
|---|---|
| Proposal 1.doc | Aug 3^{rd} 04 |
| Proposal 1a.doc | Aug 6^{th} 04 |
| Proposal 1b.doc | Aug 11^{th} 04 |
| Proposal 2.doc | Aug 15^{th} 04 |

TABLE 19

| CASE 1. | STEPS: | |
|---|---|---|
| Reader A tries to open the attachment | The system agent is invoked | |
| Proposal 2.doc sent by Writer Joe | Agent ALWAYS goes to server to check | |
| | the following | |
| | a. | IS this the current authorized |
| | | version |
| | b. | IS the user registered |
| | c. | Is the user Authorized to read this |
| | | (i.e. definition of authorized is that |
| | | the user is listed as a recipient) |
| | IF | |
| | User is Registered AND | |
| | Authorized | |
| | Then | |
| | Agent opens the document in the Browser | |
| CASE 2 | The system agent is invoked | |
| Reader A tries to open the attachment | Agent ALWAYS goes to server to check | |
| Proposal 1a.doc or Proposal 1b.doc sent by | the following | |
| Writer Joe | d. | IS this the current authorized |
| | | version |
| | e. | IS the user registered |
| | f. | Is the user Authorized to read this |
| | | (i.e. definition of authorized is that |
| | | the user is listed as a recipient) |

IF
User is Registered AND
Authorized
Then
Agent opens the document in the Browser

The Document Verification Feature

We send documents on many occasion to people who don't know who we are. An example is sending a resume to a recruiter. When the recruiter receives the document they are not certain as to the authenticity of the doc or whether the document contains any viruses etc, so they are reluctant to open it. Furthermore there is no registry that tells them anything about the recipient.

There is no sense as to HOW SAFE is this document

The intention of this feature is to
a. enable he sender to resister with the registry who they are and the document they are sending
b. enable the receiver to verify that the sender is safe

When a user registers with the service they are authenticated by the round robin email process that ensures that the sender is indeed from the email address they are registering in the system. Because the user also pays for the service using credit card there is a notion that their billing address has been verified by the credit card company.

When the receiver goes to open the document the document agent
a. invokes browser or the client application
b. goes to the server to get senders details
c. displays data to receiver
   Sample Display for the Recipient
Details of Document
Sent by: Clive Flory
Sent From: Arlington Va.
Date sent: Nov. 22, 2004
Name of Document: “My Current Resume”
Date of Document: Oct. 12, 2004
Number of pages: 12
Size: 54 K
Intended Recipient: bob@gorur.net
Click here if you wish to open the document
This is a paid service from XXX
   Document Commenting and Annotation Feature
   Problem Definition

When a reader gets a protected document from a writer there maybe a need for the reader to provide feedback and comments to the writer.

If the document is protected then the writer will NOT be able to save the document and provide inline commentary. The only option available will be as text within an email.

But this method means that the text of the comments is disassociated from the original document. So creating the comments and reading the comments outside the context of the source document could be a problem.

Use Case Scenario

Writer Joe sends a document as an email attachment to 5 people. Writer Joe wants their feedback but also wants to ensure the safety of the document.

Design Concept

Purpose

The purpose of this feature is to enable a reader to comment or the writer to read comments while having the original text alongside the comments. The KEY design element s to
a. enable the commenter to be able to comment while having THAT part that is being commented on visible.
b. enable the writer to READ the comment alongside the section that is being commented on
c. enable participants to add new comments or responses
   The Design

When a Reader tries to open a protected document they will only be able to open the document within a browser tool or a client application. These tools will have a Comment Function.

When the user selects this function the browser displays TWO panes.

The left Pane will have the document and the right pane will have the comment section Both panes will operate in their own window and will have their own independent scroll bars

There are two ways to make a comment
Text only Comment
Comment with Draw element (line, circle, square, highlight etc.)

Text only comment

In THIS method the text is associated with the page of the document currently being viewed. A page can have one or MORE comments

Comments with Draw Elements

In this method user can markup a section of a document using a draw tool (square, circle, and highlight) then they write their comment that is associated with the marked up section

Can a user Make a Response to a Comment

Authorized participants can make one or more Reponses to a comment

Can a User Make a Response to a Response

Authorized participants can make one or more Reponses to a Response

The Authentication Process

Method of Authenticating

first time opening will require a query to the server to verify the user authentication and to retrieve the decryption key and a hashed number from PCID. The hashed number ties the PC to the doc (the Ostiary Client code enforces this). then we have options:
mode 1—every access requires a query to the server
mode 2—allows offline access, after first authentication
mode 3—offline access times out after N days, etc.

### Section on Devices

Defining Devices

Shared PCs

The system caters for shared PCs. In today's world MOST work PCS are allocated to a person and there is no sharing However SOME Employees do have to share e.g. in customer care shift workers. The system will cater to this need and request MIINOR authentication process.

The Device ID and Device Fingerprint

Every Device has a fingerprint that is made up of the following:
Device ID
Intel Chip version
Intel chip ID
OS and OS version
IP Address Range of that Device
Location—Home, Work
Type—Fixed, Laptop

This information is converted to a Device ID code generated by the system, When a Device tries to access a document the IP address is recorded and associated with the Location.

Product Activation identifies a computer by considering nine characteristics, e.g. the make and model, of a variety of hardware components contained in the computer and constructs a Hardware Hash—the identifier for a computer—from the gathered information. A Hardware Hash thus represents the hardware configuration of a computer. Note that the term hardware configuration comprises, in the context of this manual, only some selected hardware components and not the full hardware configuration of the computer.

As computers typically differ in many hardware components, chances that any two computers yield the same Hardware Hash are slim. In addition, copying hardware components from one computer to another is not possible. So, Hardware Hashes meet the two conditions described above.

Hardware Hashes are sequences of 12 characters, e.g. LNKJ-BLR7-7TNZ Like Serial Numbers, Hardware Hashes are case-insensitive. Each of the characters is selected from the set of 26 letters and digits that we also use for Serial Numbers. The hardware components represented by the Hardware Hash and their considered characteristics are
one of the installed hard drives—make and model
one of the installed CD-ROM drives—make and model
one of the installed SCSI host adapters or IDE controllers—make and model
one of the installed graphics boards—make and model
The first CPU in the computer—make and model, serial number
the installed RAM—size
one of the available disk volumes—volume serial number
one of the installed Ethernet adapters—Ethernet address

Typically, the end-user may not specify of which hard drive, CD-ROM drive, etc., the characteristic is included in the Hardware Hash. The hardware components to be used are automatically determined. However, in customized Product Activation, advanced end-users can themselves select the hardware components to be considered.

From each of the collected characteristics, with the exception of the CPU serial number and the Ethernet address, a numerical value between 0 and 7, i.e. a 3-bit value, is derived. The CPU serial number and the Ethernet address are mapped to numerical values between 0 and 511, i.e. a 9-bit value. A value of 0 indicates that the corresponding characteristic is not available. If a computer, for example, did not have any CD-ROM drive installed, the value representing the make and model of one of the installed CD-ROM drives would be 0. If the installed CPU did not support a CPU serial number, the respective value would be 0. And so on. Any value different from 0 indicates that the corresponding characteristic is available. In this case the value is the result of passing a text representation of the characteristic through a hash function.

As log 2 (26) is roughly 4.7, each of the 12 characters of a Hardware Hash represents about 4.7 bits. A complete 12-character Hardware Hash thus represents a 56-bit value. We use big-endian “character ordering,” so the first character of a Hardware Hash represents the most significant 4.7 bits. The 40 least significant bits of the 56-bit value represent the hardware configuration. The remaining 16 bits contain a CRC-16 checksum to guard against typographic errors.

ON Line Authenticated Document Signature Method/Process

The Document ID Thumbprint

Every document can generate a unique Thumbprint based on the contents of the document at a particular time. This thumbprint is some unique digital string generated based on content characters and layout (number of words, characters, spaces, date, etc) If any one of the characters is altered, changed, moved then the document ends up with a NEW thumbprint. If a document remains unchanged then its thumbprint will remain unchanged.

Furthermore a documents thumbprint can be determined at any time and compared to prior determinations. In this way the system offers users an ability to record events associated with a documents thumbprint and ability to test if there have been changes by testing and comparing two documents thumbprints.

If the thumbprints are identical then the documents are the same if they are not then the docs are not identical.

The systems basically tests for

Question: “Are the two documents being compared identical”

The answer can only be a Yes or No based on the thumbprint

The system does not provide information as to HOW much change has occurred in a document if changes have been made or WHERE the changes occurred

Once this string is generated the system stores this against the document information.

NOTE the document itself need not be stored in the Ostiary server.

Providing an Electronic Signature Page for a Document (Agreement etc)

Every agreement or contract has a Signature page

Ostiary will provide the ability for parties to perform the signature process on line by

providing an on line Signature page that will be associated with the agreement.

Note the actual document need not be stored. But at some stage the document has to be analyzed by Ostiary system to generate the thumbprint and to capture the document details.

During the last stages of negotiations and once the terms and conditions have been captured on the agreement and agreed to be both sides then the document is submitted to the system for the signature process. Ostiary provides the signors an ability to generate a

Signature Page and use this as the Record.

Ostiary maintains the Signature Page.

What Data about the Signors do we Capture

The Online signature page will need to captured the following details about the signors

TABLE 20

| | |
|---|---|
| User Entered | |
| Name of Person | Joe Blow |
| Company | Verisign (automated when user signs on) |
| Email address | joe@verisign.com |
| Position | VP Marketing |
| System Entered | |
| Date first registered | |
| Number of Documents | |
| signed | |

The Signature Process

In a legal agreement at some point both parties agree to the terms and conditions captured in the agreement and both claim they are ready to sign the document

At this point the Originator submits the document to the system and creates the Signature Page

The user sets up the features of the signature page
Who and How many from both sides are signing? (name and Email address)
If there is a need for a Verifier or Witness
Is there a need for someone to authorize the signors signing capability
Details of the document (name, date, size)
All the email address of the signors (they have to know at least ONE email address of the other party)

The system generates the Thumbprint but does not store the document (this is optional and based on users request)

This thumbprint is associated with the attributes of the document
Names of parties in the document
Signing parties
Domain names
etc

Once the documents thumbprint has been generated and displayed on the Signature Page the originator can go ahead and electronically sign the signature page using their company email address.

Once the first signatory signs then the system send an email signing request to ALL other parties on the Signature page

IF the other party wants to ADD additional signatories to the page then they can log in and ADD additional names and email addresses.

What is a Verifier

A verifier is like a witness to a physical signature and a person that verifies that a signing party is still a valid person and holds a title they claim. They are people nominated by a signor who work in the same organization and who can vouch that the signor is indeed a person that works for the company and has the claimed title.

When a verifier gets a email verification request the web page they eventually see will say something like:
You have been asked to verify that it is Friday 23 September 10:40 am (today's date and time)
Joe Blow still works for Verisign and has the title of VP Marketing
Your Name:
Your Title:
Your Signature:
   Can the Ostiary Signature Server act as a Witness

The Ostiary signature server can also act as a “witness” to the parties digitally signing the documents

Can the Server Act as the Verifier

The system will also act as a verifier only of a users rights to an email ID

Multiple Signatories

In some cases the parties may request that there be multiple witnesses and hence multiple verifiers to the parties signing. In most cases ONE Verifier can verify for ALL the other signatories.

In this case the verifiers email address is entered by the signors and the verifiers also get notified

When the originator and their parties sign on line they will get an email authentication request and they will go through the round robin process

If there is a verifier required then the system requests the verifier to go through the same round robin process.

The Round Robin Process

The round Robin Process is a method that tries to ensure that the email address provided is indeed from the authorized owner and User of that email.

Method

The system generates an email authentication request and sends a message with a link to that party using the email address provided

The party opens link in the email and is sent to a web page And clicks on the confirm button

Completing the Online Signing Process

Once all the signatories and verifies have signed the document a Completion email is sent out the parties

This completion email will be like a Receipt that they can use as further proof of the process

The email will have the details:
Receipt for the Signing of Agreement
Name of the Agreement: XXXXXXXXX
Name of document
Document Thumbprint ID:
Date of Agreement
Date signing was completed:
Companies: Xyz Inc
Signatories of XYZ INC
1^{st} Signor and Verifier
2d Signor and Verifier
3^{rd} Signor and Verifier
Company: ABC Inc
Signatories of ABC:
1^{st} Signor and Verifier
2d Signor and Verifier
3^{rd} Signor and Verifier

Once done all parties get an email saying that the agreement has been signed.

Optionally the parties can store the document on the Ostiary server.

Determining the Validity of the Document

IF there is a dispute later on as to which version the parties signed then to determine this the parties do the following
a. Either party submit a document to the system to determine the thumbprint of he document
b. System determines the thumbprint
c. System searches for a match
d. If match is found the details of that agreement are displayed
e. If no match is found then the system displays a message

### Security

Levels of Security

The system can provide different level of security

Each level of security will attract a different pricing

The highest level of security is requiring the user to identify where they are when they are NOT in the two fixed areas e.g.
Office Location
Home location
Temporary Location

When users register, the system asks them for their office location.

IF they intend to access from Home they then provide their home location. Both these location are the defaults in the system and these are mapped to known IP address for that area.

When a user tries to read a doc from any of the two fixed locations the system lets it through

When a user is traveling and is in another location AND the Author has subscribed to this level of security, the system does the following:

When system validates the users email and PC ID and finds that the IP address is not in the range of fixed locations registered it takes the user to web page and says:

We note that you are in a different location form registered please tell us what
Country
State and
City

Since the system HAS the IP address of the user, it uses the information provided to verify that they are in the same location as what the system has determined.

Once done the system registers this as the Temporary Location:

User can at have at least ONE temporary location associated with the email and IP address.

Location and Address of User and Device

A user can have 3 types of location information associated with them:
Location and address of where they work
Location and address of where they live and access work related stuff
Temporary location—i.e. when they travel

When a Person (Reader or Author) registers

They tell us WHERE they are registering from (Home, Work, on the road)

And we grab the IP address

What Happens when a User Moves from Location to Location

Some employees do not move from their location of work others such as Sales Reps and

Business Development people move a lot.

For those that move a lot and where we intend to use Geo Location for testing validity of user.

The system should have the notion of users and locations of users.

A user can have
One fixed office location
One fixed Home location
One temporary location

The Settings will be as Follows

TABLE 21

| | |
|---|---|
| My Office Location | Country = USA |
| | State = Maryland |
| | City = Bethesda |
| | Post Code = 20852 |
| My Home Location | Country = USA |
| | State = Virginia |
| | City = Arlington |
| | Post Code = 22201 |
| My current Temporary Location is | Country = USA |
| | State = Virginia |
| | City = Arlington |

Verifying Ownership of Person Email Address

One of the foundations of the system is the process of a registered Author and Reader to “verify their ownership of their email address”

The purpose is to ensure that when a user registers on the Web for the service and provides their email address that the email address belongs to the registered owner.

The secondary and equally important reason is to lick the users email address with the PC that hey have sent it from.

The method for doing this is as follows
a. User registers as a Author or Reader on the system and provides their email address
b. The system sends a message to the email address with a URL link that the user is required to click on
c. The URL link sends the user BACK to the systems web site
d. When User returns the systems grabs the users PC Thumbprint and, links that to their email address.
e. The system also checks the DNS records and grabs the MX record as the record for who is the authorized delivery mail server for incoming email
f. System looks up Digital Envoys IP DB and gets Country, State and Local data
g. The system notes that it's the nth device that has been registered to the user

Registration Data for User

TABLE 22

| | |
|---|---|
| Name of User | Joe blow |
| Email Address | joe@microsoft.com |
| Company name | Microsoft |
| Device Number | The nth device that is being registered |
| | There will be a limit |
| | 1^{st}, 2ne, 3^{rd} etc Device |
| PC Thumbprint ID | 67tyw788hhjjh4877 b9899 |
| | This will be |
| | Operating System and version |
| | Intel; Chip ID |
| | etc |
| | The ID is linked to the device number |
| Incoming Mail Server address | mail-01.name-services.com |
| From DNS MX Records | |
| Local IP address of POP | 216.168.41.240 |
| associated at time of | |
| process (From Digital Envoy) | |
| Country | USA 100% |
| State | Virginia 97% |
| City of Email Address (from | Arlington 89% |
| Digital envoy) | |

When the users register on the Web Site they will get a message on the web site similar to this:

A Verification e-mail message has successfully been sent to your Inbox.

To better protect your privacy, Ostiary requires that you verify ownership of your e-mail address prior to enabling you view the Document.

Please follow the steps to verify your e-mail address.

After you verify your email address, you will be able to view the Secure document

The email address we have sent the verification to is joe@microsoft.com
Step 1. Open the email sent from verification@ostiary.com
Step 2. Click on the verification link
Step 3: System will take you back to the Verification section of the Ostiary site to verify your address
   Sample of the Email Address form Ostiary to Reader or Author

The user gets this sample email:

Final Step

To verify that you own this e-mail address, click, https://verification.ostiary.com/verifyvalidateemail/ProcssEmail.aspx?1cid=1033&Email Entered=joe%40blow.info&eck=w2UTkwbApcMkcpEDJsoq9Q&CP=2&WizID=c0984801-c59c-43fc-a8d6-1.

*If clicking the link above does not work:

Select and copy the entire link.

Open a browser window and paste the link in the address bar.

Click Go or, on your keyboard, press Enter or Return.

You may be asked to sign in with a Microsoft.NET Passport.

Do not reply to this message. This e-mail message has been sent from an unmonitored e-mail address. We are unable to respond to any replies sent to this e-mail address.

If you continue to have access problems or want to report other issues, please Contact Us.

When the user clicks on the URL link in the email hey will be taken back to a Verification Page on www.verification.ostiary.com

On this page they get this message:

Mail Verification Confirmation

Mr. Joe Blow form Microsoft you have successfully verified your e-mail address joe@microsoft.com with Ostiary Your Can now view all documents protected by Ostiary.

How Many Devices can a User Access Secure Documents from

A user can access documents from a restricted number of devices
From Their corporate PC
Their Laptop
Their Home PC

The system will bind a user corporate email to 1 or 3 devices based on the business rules In all cases the email and the PC's ID is bound and in ALL cases the user will have to go through the Email Verification method to bind the PC thumbprint.

What Happens when a user CHANGES their PC?

They have to go through a Device registration which is registering device ID and associating Email ids to this device

This is a Device only registration

How Many LOCATIONS can a User Access Sensitive Documents from

A user can access documents from ANY location in the world

Provided the Author has not restricted the access to certain locations

The system could restrict Persons access to few locations with ability to request for

Location extension to the Author.

The Ostiary Seal—your Email ID

Background

In many situations we check the credentials of people that we are dealing with—in banks, for building access, employee records, access to systems.

In the digital world and in particular with regards to email we don't have such an ID that enables someone to know that the sender is authentic. In the physical world, it takes considerable effort to change our physical appearance to assume another individual's identity however this is a simple task for email communications.

In all cases, a 3^{rd} party provides a person with an ID. This ensures that the 3^{rd} party has verified aspects of that person. In most cases this is done in person and requires that the person bring proof of claim of identity. Proof of claim of identity usually is drivers licence, Passport, Birth certificate, Bills from place of residence
The Individual Seal
The Company and Employee Seal

The Ostiary Seal will be an additional service that an Individual or Employee of a company can opt to get. In doing so there are some conditions and process that the company and employees need to go through to get the seal.

NOTE: Since employees are given an email address when they join and email addresses are revoked when they leave we can use this condition to control when a users Seal gets revoked without the need of an administrator.

This would however that the Email Server administrator send updates on current list or those that have been removed

The Basic Design Concept

The basic design is to
a. Enable a Company to request the Seal Service
b. Establish an Administrator or Seal Authoriser within the organisation (unless we create a self serve model )
c. Enable an Employee to Register for Personal Seal
d. Enable System to deregister Person form using Company Seal

Once a user has registered for a Seal they are able to use the seal in an Email.

Sample of Employee Seal

Ostiary
Graeme Marsh
VP Sales and Marketing
Ostiary ID Seal issued Jul. 23, 2004 3:23:00
To verify click here
   How a Seal is Used
A user opens an Email and writes the message and maybe attaches a document.
From the tool bar user clicks the “INSERT SEAL” button
The agent checks the users email address
Agent interrogates the Seal Server looks up the seal associated with the email address and places a Generic Ostiary Seal in the email

(NOTE: At this stage the system does not know if the email address in the From field is actually the one being used)

Users then clicks SEND

NOTE: System has to ensure that the email address is legitimate

Opening an Email with a Seal

When the recipient gets the email and opens the email an agent attached to the email interrogates the seal server

Looks for the seal associated with the email

Places the seal in the email.

How to get the Ostiary Seal

To get the Ostiary seal the requestor also gets verified by Ostiary . The method to verify is however done electronically and with human intervention.

When a user registers for the Protection service they register as an Individual or as an employee of a company. In either case the process will be different.

TABLE 23

| Type | Description |
|---|---|
| As An employee of a | Before an Employee of a company can get a seal the |
| Company | Company itself must subscribe to the service. |
| | Someone from the organisation is nominated to “authorise |
| | “requests for seals. (See process and UI for being |
| | nominated as “Seal Authoriser” |
| Process | Company Registering for the Ostiary Seal Service |
| | To register for the Seal service the company must be already |
| | registered for the Document Protection Service |
| | Once registered the company can get the Seal service by doing he |
| | following |
| | a. Log on to web site as Administrator |
| | b. Select Seal Service |
| | c. Register who in their organization will be the |
| | administrator and internal authoriser of seals |
| | d. Go through the Ostiary verification process for the |
| | proposed administrator |
| | Once the Authorised Administrator and Seal |
| | Administrator has been setup then the employees can |
| | register for their personal seals |
| | Revoking a Employees Seal |
| Process: | When an employee requests a seal steps |
| | This assumes that |
| | a. The company is already registered for the service |
| | b. The employee is already registered as a Reader or |
| | Writer |
| | c. The registered company has opted to take the Seal |
| | Service |
| | d. Someone has been appointed as the Companies |
| | “Seal” authoriser |
| | Employee logs onto system using us |

The Ostiary Seal Design

The Seal is a simple object created on the fly that has the following data elements

TABLE 24

| Data Element | Example |
|---|---|
| Name of Company | Ostiary INC |
| Employee Name | Graeme marsh |
| Employee Position | EVP Sales and Marketing |
| Date and Time Seal issued | 07-23-04 3:23:00 |
| Colour | Blue = |
| | Red = |
| | Yellow = |

Ostiary INC
Graeme Marsh
VP Sales and Marketing
Ostiary ID Seal issued Jul. 23, 2004 3:23:00
To verify click here
   Revoking a Seal

A seal can be revoked for the following reasons and by the following people

An employer can revoke a seal from an employee for whatever reason

Ostiary can revoke All seals for a Company but cannot revoke a seal for an individual employee.

Ostiary seals bring an additional level of trust to emails—in the same way as identity tags provide additional trust in our everyday workplace.

### The NDA Registry System

The NDA Register

In many cases sensitive documents get exchanged AFTER an NDA has been signed between two people or two companies

The NDA essentially says that any information the company exchanges will be kept private and for the eyes of the company and their employees only.

The system will provide number of functionality
a. It will act as a central registry for companies that enter into an NDA relationship thereby enabling them to keep track of which companies they have an NDA with, Who entered the NDA agreement, when it expires, etc
b. It will attempt to replace the paper based NDA version with an online version using the Document protection Infrastructure

The intent is to tie the NDA registry to the Document protection system.

The Concept

The NDA Registry is a central registry enabling a company to keep track of all NDAs that they have entered into

The Registry can cater for documents that require physical signatures

But the registry will enable the ability to create NDAs with digitally signed signatures

The registry will also provide access to a template of standard NDA S that users can use if they don't have their own

The system can be used in conjunction with the Document Protection system to prevent documents sent from Company A to ONLY go to recipients whose email addresses are that of the signatory Companies

The Registry

IF Company A has entered the NDA details and Company B joins later then they can see the same NDAs and associate this with their details:

The NDA Data

Name of your Company

Name of the other party

The date of the NDA

The address details

The names of the signatory

The position of the signatory

The restriction i.e. only for Division

The domain names of the recipient companies that can use the documents

(The ability to block a NDA from being sent to or read in countries outside USA, for example)

The Domain Protection

With NDAs there is the notion that the NDA covers all employees within an organization.

How will the NDA registry and the document protection system work:

If two companies are registered in the NDA registry and any employee sends a document to another employee in that organization the system does the following
a. Checks the email; address of the sender
b. Looks at the Domain element of the email address
c. Looks at the recipient email and specifically at the domain element
d. Checks to see if the two parties have registered any NDA agreements
e. If so it enables members of the companies to exchange documents in a secure manner
   Membership Rules

An Individual can subscribe for the Services

A company can subscribe for the services

General Notes:

The Processes

The Subscription Process

User subscribes
They register their details
They see the service options available
The select the service they want

The Upgrade Service Process
They are able to upgrade the service plan
The Document Protection Process
The Web Protection Process

Using the System to define the community of people that can see your stuff

Defining the rules for what people outside of this community can do with your stuff

System Architecture

DRM Server can be Centralized or distributed

A Server holding the Docs can be as an ASP service and centralized for Small, SOHO and Personalized versions

Enterprise markets will probably use their own Servers to hold their own documents but use Ostiary DRM systems to hold the Key infrastructure and the Comments and annotation data

The R&P system can be centralized or decentralized and distributed So Enterprise users can host their own R&P servers

Billing will be Central for US

Using Unique Values to Create a Protection System

The purpose of this section is to describe the method, process and elements involved in constructing a Protection System

There are many unique elements in the system that will enable us to use to create a

Protection system or Protective Ecosystem

The Unique Objects and their Elements

TABLE 25

| Object | Uniqueness |
|---|---|
| Companies Unique | Most companies have their own domain names. |
| Domain Name | Every domain name is unique |
| | When a company has their own domain names they |
| | generally use this to create their employees email address. |
| | Example: Your_Company_Name |
| Readers Authors | Every employee is given a email address constructed in the |
| Unique Email | form of emploees_name@companies_name.com |
| | This email address is unique at the Company AND in the world |
| Document ID | Every document has a unique ID and based on elements of the |
| | document a Unique ID can generated |
| | The elements can be |
| | Content |
| | Author name |
| | Date and time of Document |
| | etc |
| Readers PC | Every Readers PC or device has some unique characteristics |
| | Examples are |
| | make and model of one of the installed hard drives- |
| | make and model and model of one of the installed CD- |
| | ROM drives- |
| | make and model of one of the installed SCSI host |
| | adapters or IDE controllers- |
| | make and model of one of the installed graphics boards- |
| | make and model, serial number of the first CPU in the |
| | computer- |
| | size of the installed RAM- |
| | volume serial number of one of the available disk |
| | volumes |
| | Ethernet address one of the installed Ethernet adapters - |
| | These characteristics can be used to generate ONE hardware Hash |
| | Code for that device |
| Readers Access | Generally a Reader access the Internet from a minimum of 2 |
| Location | Key areas |
| | Workplace |
| | Home |
| | In both cases the IP address and the Location of the Access |
| | Providers POP for that location can be determined |
| | This can lock in the location characteristics of a user |

Other Scenarios:
Securing and Trusting the Email Attachments

Users are afraid of opening email attachments. When a user receives an attachment secured by the system there is a level of trust that they are getting the document from someone they know and that the attachment is secure. How to let users know that the attachment is from a secure environment

We introduce the concept of the registered user

When a user wants to secure the doc they register once

The system adds a logo to the email attachment so when the user receives the email.

A good example is: Say, Nextel and Wal-Mart have a project where Nextel is launching their products in Wal-Mart stores . Say Joe Blow is the project lead at Wal-Mart and Jenny Craig is the lead at Nextel. Now Joe has NO CLUE who is in Jenny's team and should not know, and Jenny has no clue who is in Joe's team.

However, the companies have entered into an agreement, and these two are officially the points of contact.

Say, Joe sends Jenny a doc, and it is protected. Jenny needs to send this Doc to her team.

How does she do this:

In this environment there is an implied TRUST between two points of contact between the two companies

Because of this we introduce the idea of “Forwarding Rights”

In this scenario Joe prepares the doc to send to jenny and turns on the attribute enable

Forwarding rights

When Jenny gets the doc she is able to forward the doc to her team members and JOE is

NOT involved in this process. But relies on Jenny's sense as to who should get the doc

On the systems audit trail which shows who DOES get the doc from jenny

Now Jenny can also send the doc with forwarding rights to the group or can withhold this

If she has withheld this and someone in her group tries to forward the doc, the unauthorized person is unable to open the message, and Jenny will get a message telling her who in her team tried to forward the doc.

The system can have say 1 level of forwarding or two levels.

In this way there won't be a need to have groups and manage this complexity

And we rely on the fact that the INITIAL two people have a shared and implied trust

Naturally. if there is no Forwarding Rights on a document, then Jenny would NOT be able to forward.

The other method was to have a concept called “Request to Open”

Say Joe ends Jenny a Doc with NO forwarding rights

Jenny send doc to 5 people who try to open

The system sends Jenny and Joe with a message saying that there has been a request to open by this list of people

Joe and Jenny allow or don't allow
The fact that people WILL know that the original senders will be notified if illegal access is tried will be a HUGE deterrent for people to send documents illegally

In this way the system self manages and removes the need for the complex issue of Groups

There are two concepts or objects here
1. The trusted registered user
2. The Group
3. The Document in question

The system provides some smarts and protection for both objects independently and as a combination.

The Member Object

Being a member of the trusted group is a bit like signing a CENTRAL NDA with us and allowing everyone to share the benefits of that one time NDA signing. It also means that others can send you stuff, knowing that you are already setup to read their protected documents.

Since the system can track what a member does with respect to forwarding a protected doc that they were not supposed to forward the system can monitor this and based on rules do something if you transgressed this say 5 times. In other words, you get revoked when a member registers the system gets User Name Password Email Address Users PC fingerprint.

The Group

The Group could have its set of rules that govern that group and they could inherit from a Global Group set of rules to classes of groups that we setup, e.g. CFO class, CEO class, VP class.

The Document Object

The document has its own set of rules that govern behavior Once a Doc is an attachment to an email when its sent the System grabs the email address of the recipients and allows access to the document only from those recipients If a user tries to open it requires not only the recipients user name and password but also checks the PC Fingerprint. If this does not match up then the document just does not open. The system then sends an email to both the original sender and the recipient who forwarded the attachment letting them know that there was an attempt at unauthorized access.

You've pointed out an interesting thing: the notion of a trusted user based on registration. A trusted user can be sent documents from multiple sources with security ensured.

Tracking Documents Sent

There is a general need to track documents enabling an Author to see Who sent What to Whom and When

Some of the areas to track are
a. What documents did I (Mr. user) send, When did I send and to whom
b. Was it received and Did they open it
c. Did any of the recipients forward the document to an unauthorized Reader

The purpose is to enable Authors to see who is sending what sensitive documents to which unauthorized Readers

Tracking WHO sent WHAT Document to WHOM

When an Author or Sender attaches an Ostiary prepared document to an email and that email is sent, then the details of that transaction have to be registered with the Ostiary server. Information such as
Name of Author
Name of Sender
Name of Document
Version of Document
Date and Time of Document
Author info of Document
Recipients of Document Should be captured.

This method has to be automated unless the Sender is using the Web based method to make a document available.

Since a Recipient of a document can forward that document to an unauthorized user there is a need for the Author to track this. Not all Authors will want this so there is a need to enable the Author tell the system if they wish to track “Unauthorized forwarded” documents.

In this way the server maintains a record of ALL Recipients that receive the document.

Notifications

An Author can request that they be notified whenever a document has been sent to an unauthorized Reader. When this occurs the Author will be sent an email notification of the event (If this is turned On )

Notification can be done by email, SMS, etc.

The system has to enable the Author to select this option

Document History

TABLE 26

| | |
|---|---|
| Document Name: | The potential merger of Microsoft and IBM .doc |
| Name of Author: | Bill Gates |
| Sent By | Sarah McDonald |

TABLE 27

| | Date First | | | | | | | Date |
|---|---|---|---|---|---|---|---|---|
| Doc | Sent by | | | | Company | | | re- |
| Ver | Author | Recipients | Email Address | Location | Name | Web Site | Date opened | sponded |
| 1.0 | Aug 12^{th} | Bill Gates | bgates@microsoft.com | Internal | Microsoft | www.microsoft.com | Aug 15^{th} 04 | |
| | 04 | Louis Gerstner | lgerstner@ibm.com | External | IBM | www.ibm.com | 12:19:45 | |
| | 12:16:53 | John Berry | john.berry@morganstanley.com | External | Morgan Stanley | www.morganstanley.com | | |
| | | Jenny Brighton | jbrighton@lehmanbros.com | External | Lehman Bros | www.lehmanbros.com | | |
| | | Jeremiah | jjohnson@citoibank.com | External | CitiBank | www.citoibank.com | | |
| | | Johnson | | | | | | |

Unauthorized Forwarding

TABLE 28

| Sent by | Sent Email | Sent to | Date Sent | Open Attempt |
|---|---|---|---|---|
| Bill Gates | Larry.ellison@oracle.com | Larry Ellison | Aug 21^{st} 04 | None |
| | Scott.McNealy@sun.com | Scott McNealy | Aug 21^{st} 04 | Twice |
| Jenny Brighton | jeff.borland@blrland.com | Jeff Borland | Aug 22^{nd} 04 | Three |
| | sam.aldus@citibank.com | Sam Aldus | Aug 23^{rd} 04 | None |

Authorized Forwarding

TABLE 29

| Sent by | Sent Email | Sent to | Date Sent | Open Attempt |
|---|---|---|---|---|
| Louis Gerstner | Larry.ellison@oracle.com | Larry Ellison | Aug 21^{st} 04 | None |
| | Scott.McNealy@sun.com | Scott McNealy | Aug 21^{st} 04 | Twice |
| Jenny Brighton | jeff.borland@blrland.com | Jeff Borland | Aug 22^{nd} 04 | Three |
| | sam.aldus@citibank.com | Sam Aldus | Aug 23^{rd} 04 | None |

Notes:
when an Author SENDS a document we won't have the name of the recipients but only their Email address. The ONLY way we will get the name is when the Reader registers. If a Reader sends a document to an unauthorized unregistered person then we will only have their email address.

What Happens when a Reader Gives up their Email Address

Like telephone numbers a reader can cease using their telephone number and someone else can get this.

Re-Authenticating a Reader and their devices

There are many reasons why there is a need to re-authenticate a Reader
a. When they sell their Device
b. When they give away their device
c. When their device has been repaired

Methods:
if a user starts using a new device, he gets re-authenticated.
as part of the re-authentication process, he can disable the old device(s)
we may want a provision to disable a device after a long period of no use. The user can always re-register.

a single password for all Ostiary docs the reader has is required. We may want to use .Net at some point as an option.

TABLE 30

| Object | Description | Links |
|---|---|---|
| Publisher/ | A Publisher or Author Publishes things These are called | Protected Published |
| Author | Protected Published Objects | Objects |
| | Examples of PPO are | |
| | Documents | |
| | Music | |
| | Video | |
| Protected | Either these objects are | Authorized Access List |
| Published | for FREE access or | Unique Object ID |
| Objects | for authorized access | |
| | The Publisher grants Authorized Reader Access on the | |
| | basis of | |
| | a. Privilege | |
| | b. Payment | |
| | c. Other reasons | |
| | Once access is granted to a Reader the Readers details | |
| | are entered into an Authorized Access List. | |
| | Every PPO has a Unique Object ID that identifies that | |
| | object. The Unique Object ID is potentially generated | |
| | differently for different Object types | |
| Authorized | This is the DB that contains | Unique Object ID |
| Access List | the list of all Authorized Readers | Readers Digital ID |
| | the PPO that they are authorized to access | |
| | Their Details (name, Internet address etc) | |
| Object ID | This is the Unique ID(a long string) that is generated for | Current cookie |
| | each Object. Part of the ID contains info on the Object | Unique Object Keys |
| | Type | |
| | For example the Doc ID is generated from | |
| | a. Object Type | |
| | b. Name of Document | |
| | c. Date and time | |
| | d. Content | |
| | e. Authors name | |
| | f. etc | |
| | The ID is encrypted | |
| Object Keys | Every Object is encrypted when sent to a Reader | |
| | The keys used to encrypt and de-crypt the object are | |
| | central to Access of the Object | |
| Readers | Every Reader that is registered with the central system is | Device ID |
| Digital ID | given a Unique Digital ID | Readers Details |
| | This ID is generated from a number of data elements | |
| | including | |
| | Person e-mail address | |
| | Their PC Hardware ID elements e.g. CPU number, | |
| | Mac Address | |
| Current Cookie | Cookies are generated by the Ostiary server and placed | |
| | on a Readers Device EVERYTIME a Reader makes a | |
| | request for access to a document. | |
| | At the server end Cookies are Associated with | |
| | a. ALL Object IDS that a Particular Reader is | |
| | Authorized to access | |
| | b. ONE of the Readers Digital ID associated with a | |
| | particular Device | |
| | Cookies are associated with is used to ensure that | |
| | a. The Requesting Device is a registered device | |
| | b. That A cookie is generated at the Ostiary server | |
| | and associated with | |
| | A particular Objects ID | |
| | A particular Readers Device ID | |
| | When a Reader wants to have access to a Document the | |
| | Ostiary Server asks the Question “what is the cookie | |
| | number” | |
| | The BPI then supplies the cookie and the Document ID to | |
| | the Ostiary server | |
| | The Ostiary server then checks if the cookie | |
| | received, matches the Document ID on the server | |
| | receiving the cookie it can determine if that cookie | |
| | should get access to the document being requested. This | |
| | is the first simple pass MATCHING. It leaves a cookie | |
| | ID. | |
| | Every time The cookie ID is associated with | |
| | The Readers Digital ID. | |
| | the Object IDs Every time it communicates it leaves a | |
| | different cookie | |
| | The cookie is used to determine if the sending Readers | |
| | Device | |
| Readers | A Reader can have many devices | |
| | Each Device has one Device ID | |
| | A reader has only ONE email from one employer at any | |
| | one time | |
| | But a Reader can have more than one employer | |
| | Example: A consultant working for company x and | |
| | working for their own company will have two email | |
| | addresses | |
| | A reader can use their ISPs email address | |
| | A reader can have more than one digital ID | |
| Devices | Each Device has to be able to generate some unique | |
| | Device ID | |
| | This is done either form a single data element or | |
| | From a composite of data elements inherent to that device | |
| Email | While a Reader may be employed by several companies | |
| | EACH company will only provide ONE email address | |
| | But a Reader can have several Emails | |
| | Example | |
| | Joe Blogs can have the following | |
| | Private: joebloggs123@yahoo.com | |
| | Main Employee: joe.bloggs@greatconsulting.com | |
| | Company consulting to: jbloggs@microsoft.com | |
| | Their OWN Company: joe@bloggs.biz | |
| | But the emails are independent of the devices being used | |
| | and ALL emails could be used on ALL devices from | |
| | Outlook or Web Based email | |
| Readers | Each Digital ID is a combination of Email and Device ID | |
| Digital ID | The Same device can have two or more Digital IDs | |
| | operational on that Device ID | |

In general the system associates the Reader with
the Devices they use
The Email address they get

Since a Reader can have one or more of both the result is a matrix

The result is that the Reader can get as many as 4×3=12 Digital IDs registered in the system. This is like getting 12 Credit cards from 12 different companies.

Email to Device Matrix for a Reader

TABLE 31

| | Device 1 | Device 2 | Device 3 |
|---|---|---|---|
| Email 1 | Email 1. Device ID 1 | Email 1. Device ID 2 | Email 1. |
| | | | Device ID 3 |
| Email 2 | Email 2. Device ID 1 | Email 2. Device ID 2 | Email 2. |
| | | | Device ID 3 |
| Email 3 | Email 3. Device ID 1 | Email 3. Device ID 2 | Email 3. |
| | | | Device ID 3 |
| Email 4 | Email 4. Device ID 1 | Email 4. Device ID 2 | Email 4. |
| | | | Device ID 3 |

Furthermore a Device can have different players from different vendors and a Player can be installed on different devices owned by the Reader

But each player installed on each device will have a unique serial number Player to Device matrix

TABLE 32

| | Device 1 | Device 2 | Device 3 |
|---|---|---|---|
| Player 1 | P1.SN.x1. | P1.SN.x2. Device ID 2 | P1.SN.x3. Device ID 3 |
| (P1) | Device ID 1 | | |
| Player 2 | P2.SN.x4. | P2.SN.x5. Device ID 2 | P2.SN.x6. Device ID 3 |
| (P2) | Device ID 1 | | |
| Player 3 | P3.SN.x7. | P3.SN.x8. Device ID 2 | P3.SN.xn. Device ID 3 |
| (P3) | Device ID 1 | | |

Each Device has ONE cookie regardless of the number of 3^{rd} Party Players installed.

ALL players will use the Ostiary cookie for that Device.

Cookie to Device Matrix

TABLE 33

| | Device 1 | Device 2 | Device 3 |
|---|---|---|---|
| Cookie 1 | Cookie 1. | | |
| | Device ID 1 | | |
| Cookie 2 | | Cookie 2. Device ID 2 | |
| Cookie 3 | | | Cookie 3. Device ID 3 |

Every Reader registered will have ONE user name and password

Reader to User Name and Password

TABLE 34

| | Device 1 | Device 2 | Device 3 |
|---|---|---|---|
| Cookie 1 | Cookie 1. | | |
| | Device ID 1 | | |
| Cookie 2 | | Cookie 2. Device ID 2 | |
| Cookie 3 | | | Cookie 3. Device ID 3 |

Associating Many Email and Digital IDs under one Reader Name

A Reader could have many email address and Device resulting in many Digital IDs. The system has to enable a Reader to consolidate all IDS and emails under one roof This means that a Reader can register and get a Normal User account and have this one user account consolidated.

In principle a Reader can have several Identities based on their association with that entity:
My Private Identity
My Id with my Employer
My ID with the company I consult with

In all cases, these can be generated independently. At any time, a Reader can consolidate.

Note: Any variation of the teachings above is also intended to be covered and protected by the current patent application.

1. A system to manage, control, track, or monitor access, usage, view, provide comments, or provide collaboration environment for digital contents or services, said system comprising:
an environment to offer digital contents or services by a provider; and
a network of one or more computers, telephones, communication devices, mobile devices, wireless devices, cellular devices, PDAs, electronic devices, nodes, routers, hubs, optical devices, connection means, or switches,
wherein said provider or another entity assigns one or more rights, constraints, limitations, or privileges to one or more users,
wherein said one or more users operate, access, or use said network, and
wherein said one or more users are controlled, monitored, constrained, or limited by said one or more rights, constraints, limitations, or privileges.

2. A system as recited in claim 1, wherein said system is used in an ASP service.

3. A system as recited in claim 1, wherein said system is used to collaborate on or jointly edit or modify a common document or digital content.

4. A system as recited in claim 1, wherein said system incorporates an encryption and/or electronic signature scheme, method, or module.

5. A system as recited in claim 1, wherein said system incorporates one or more of the following for the authentication process: an e-mail ID, password, biometrics, digital certificate, hardware ID, software ID, cell phone ID, or a random number generator on a USB device.

6. A system as recited in claim 1, wherein said system enables a federated approach to control, monitor, or manage the comments, inputs, or feedbacks, and/or enables a federated or centralized approach to managing the distributed user's authentication and authorization, for all companies in a given country or spread globally.

7. A system as recited in claim 1, wherein said system provides a mechanism to move a threaded conversation, e-mail trail, feedback trail, input, reply trail, response trail, or continuous collaboration from one version to another version.

8. A system as recited in claim 1, wherein said system manages one or more registered users and providers as a part of a community, circle, secured network, private network, virtual trusted network, or closed network.

9. A system as recited in claim 1, wherein said system provides a mechanism to enable users in a circle to inherit items or characteristics supplied or applied by a provider, in addition to the users' own items or characteristics.

10. A system as recited in claim 1, wherein said system provides continuous and persistent protection for said provider.

11. A system as recited in claim 1, wherein said system provides a safe forum for exchanging, sharing, editing, conferencing, or collaboration on sensitive or confidential business information, through one or more documents, one or more web sites, or one or more business blogs.

12. A system as recited in claim 1, wherein said system provides a network-based management of shared electronic files.

13. A system as recited in claim 1, wherein said system is used on the Internet.

14. A system as recited in claim 1, wherein said system is used for one or more of the following applications: information about a merger or acquisition, companies' financial information, proprietary information shared with a corporate partner, information about a new product launch, research information around a proposed new patent, HR or compensation information on employees, or an intranet web site.

15. A system as recited in claim 1, wherein said system enables companies to send documents anywhere in the world, and receive a high level of protection, regardless of the location of users.

16. A system as recited in claim 1, wherein said system provides the foundation for a user, document delivery agent, or digital identity created from a composite of elements.

17. A system as recited in claim 1, wherein said system provides hierarchical structure for the documents or contents.

18. A system as recited in claim 1, wherein said system provides hierarchical structure for the rights.

19. A system as recited in claim 1, wherein said system provides hierarchical structure for the services.

20. A system as recited in claim 1, wherein said system provides composite documents or contents.

21. A system as recited in claim 1, wherein said system provides composite rights.

22. A system as recited in claim 1, wherein said system provides composite service offerings.

23. A system as recited in claim 1, wherein said system provides one or more withdrawn rights or expired rights.

24. A system as recited in claim 1, wherein said system provides executable codes.

25. A system as recited in claim 1, wherein said system provides a central non-disclosure agreement registry for one or more entities or companies.

26. A system as recited in claim 1, wherein said system provides a secure guaranteed on-line signing process for business or non-business contracts and agreements.

27. A system as recited in claim 1, wherein said system provides a method to segregate threaded document messages into two or more message channels.

28. A system as recited in claim 1, wherein said system is used in a court or a legal organization.

29. A system as recited in claim 1, wherein said system provides the view of or access to the content for a selected set of users.

30. A system as recited in claim 1, wherein said system enables multiple users and/or providers manage different versions of the same original digital object.

31. A system as recited in claim 1, wherein said system provides a receipt of delivery and receipt of initial access.

32. A system as recited in claim 1, wherein said system provides alert to said provider.

33. A system as recited in claim 1, wherein said system provides notification of the key events.

34. A system as recited in claim 1, wherein said system is based on a browser-based or a desktop application.

35. A system as recited in claim 1, wherein said system provides link between digital objects.

36. A system as recited in claim 1, wherein said system provides link to one or more databases.

37. A system as recited in claim 1, wherein said system provides means of changing or viewing authorship and/or ownership.

38. A system as recited in claim 1, wherein said system interacts with an address book.

39. A system as recited in claim 1, wherein said system provides a role or context-based right assignment.

40. A system as recited in claim 1, wherein said system provides a usage policy.

41. A system as recited in claim 1, wherein said system uses biometrics, fingerprint, signature, header, hash, or any other unique features for authentication.

42. A system as recited in claim 1, wherein said system provides the document or digital object keyword list.

43. A system as recited in claim 1, wherein said system provides employee registration.

44. A system as recited in claim 1, wherein said system provides audit trails.

45. A system as recited in claim 1, wherein said system provides digital signature and approval for documents, comments, or actions.

46. A system as recited in claim 1, wherein said system provides the delegation of one or more rights to another entity.

47. A system as recited in claim 1, wherein said system provides a digital license or a token.

48. A system as recited in claim 1, wherein said system provides a method to segregate threaded document messages into private and public message channels between two or more companies, and/or within each divisions or functions of a company.

49. A system as recited in claim 1, wherein said system provides a mechanism that enables two or more users to share the simultaneous viewing of a document, wherein one of the users has the control of the document and its changes, actions, or movements.

50. A system as recited in claim 1, wherein said system presents intensity of the relationships as an indication of the frequency of interactions for one or more documents and the users.

51. A system as recited in claim 1, wherein said system presents intensity of the communication relationship as an indication of the frequency of interactions with comments for one specific document or series of documents.

52. A system as recited in claim 1, wherein said system uses the frequency of the usage of the keywords as an indication of the interest level of said provider or user with respect to the subject matter or keywords.

53. A system as recited in claim 1, wherein said system provides classification using keywords.

54. A system as recited in claim 1, wherein said system uses two or more keywords sharing some basic or fundamental concepts, to be able to classify.

55. A system as recited in claim 1, wherein said system stores history and activity.

56. A system as recited in claim 1, wherein said system status, parameters, or appearance is dynamically changing.

57. A system as recited in claim 1, wherein said system interacts with a group of users to expose and analyze the social interactions that arise from the shared objects.

58. A system as recited in claim 1, wherein said system only stores one copy of the e-mail for all the recipients or users.

59. A system as recited in claim 58, wherein said system prevents forwarding the e-mail to a third party.

60. A system as recited in claim 58, wherein said system allows the removal of a non-intended recipient's name from the list of recipients in an e-mail, and wherein said system further allows the removal the right to access or usage associated with said non-intended recipient.
